(19) United States
(12) Patent Application Publication
(10) Pub. No.: US 2026/0270407 A1
(43) Pub. Date: Sep. 10, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Wenbin YIN, Beijing (CN); Kai ZHANG, Los Angeles, CA (US); Yang WANG, Beijing (CN); Li ZHANG, Los Angeles, CA (US)

(21) Appl. No.: 19/664,875

(22) Filed: Apr. 30, 2026

Related U.S. Application Data
(63) Continuation of application No. PCT/CN2024/128535, filed on Oct. 30, 2024.

(30) Foreign Application Priority Data
Oct. 31, 2023 (WO) PCT/CN2023/128553

(51) Int. Cl. H04N 19/105; H04N 19/176; H04N 19/80

(52) U.S. Cl. CPC H04N 19/105; H04N 19/176; H04N 19/80

(57) ABSTRACT

Embodiments of the present disclosure provide a solution for video processing. A method for video processing is proposed. The method comprises: for a conversion between a current video block of a video and a bitstream of the video, prediction samples of the current video block are determined; the prediction samples of the current video block are updated based on a filtering process; and the conversion is performed based on the updated prediction samples.

### CROSS REFERENCE TO RELATED APPLICATIONS

This application is a continuation of International Application No. PCT/CN2024/128535, filed on Oct. 30, 2024, which claims the benefit of International Application No. PCT/CN2023/128553 filed on Oct. 31, 2023. The entire contents of these applications are hereby incorporated by reference in their entireties.

### FIELDS

Embodiments of the present disclosure relate generally to video processing techniques, and more particularly, to filtering process on prediction samples.

### BACKGROUND

In nowadays, digital video capabilities are being applied in various aspects of peoples' lives.

Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, prediction samples of the current video block; updating the prediction samples of the current video block based on a filtering process; and performing the conversion based on the updated prediction samples. The method in accordance with the first aspect of the present disclosure enables filtering prediction samples in video coding.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining prediction samples of a current video block of the video; updating the prediction samples of the current video block based on a filtering process; and generating the bitstream based on the updated prediction samples.

In a fifth aspect, a method for storing a bitstream of a video is proposed. The method comprises: determining prediction samples of a current video block of the video; updating the prediction samples of the current video block based on a filtering process; generating the bitstream based on the updated prediction samples; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates example of encoder block diagram;

FIG. 6 illustrates a picture with 18 by 12 luma CTUs that is partitioned into 12 tiles and 3 raster-scan slices;

FIG. 7 illustrates a picture with 18 by 12 luma CTUs that is partitioned into 24 tiles and 9 rectangular slices;

FIG. 8 illustrates a picture is partitioned into 4 tiles, 11 bricks, and 4 rectangular slices;

FIG. 9A-FIG. 9C illustrate examples of CTBs crossing picture borders, where FIG. 9A illustrates CTSs crossing the bottom picture border, FIG. 9B illustrates CTSs crossing the right picture border, and FIG. 9C illustrates CTBs crossing the right bottom picture border;

FIG. 10 illustrates 67 intra prediction modes;

FIG. 11 illustrates an illustration of picture samples and horizontal and vertical block boundaries on the 8×8 grid, and the nonoverlapping blocks of the 8×8 samples, which can be deblocked in parallel;

FIG. 12 illustrates pixels involved in filter on/off decision and strong/weak filter switch;

FIG. 13A-FIG. 13C illustrate filter shapes for ALF, respectively;

FIG. 14A-FIG. 14C illustrate relative coordinator for the 5×5 diamond filter support, respectively;

FIG. 15 illustrates examples of relative coordinates for the 5×5 diamond filter support;

FIG. 16 illustrates a flowchart of a method for video processing in accordance with embodiments of the present disclosure; and

FIG. 17 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

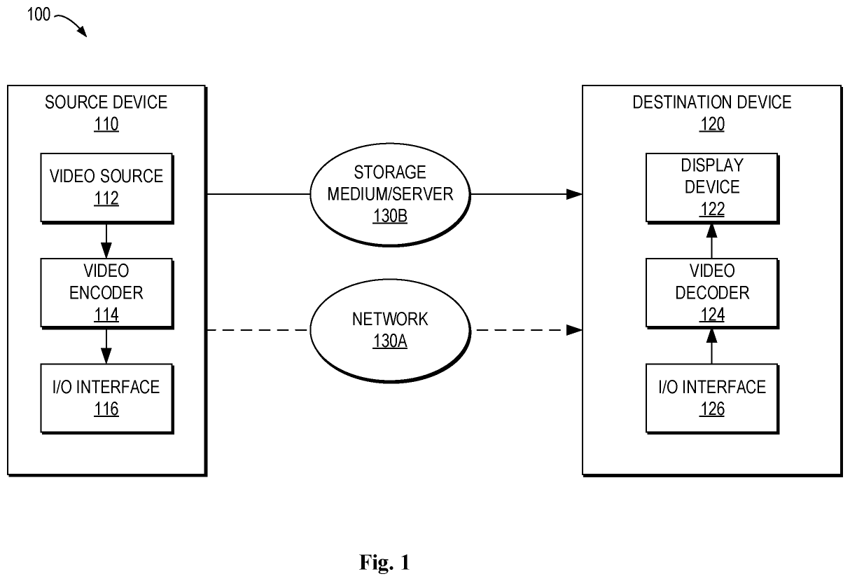

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

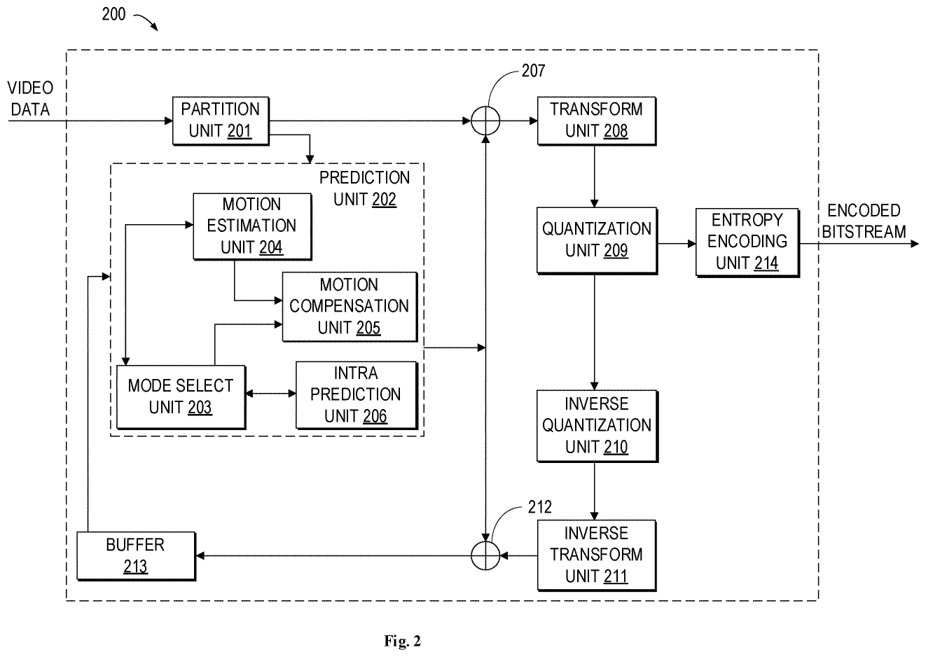

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block.

The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

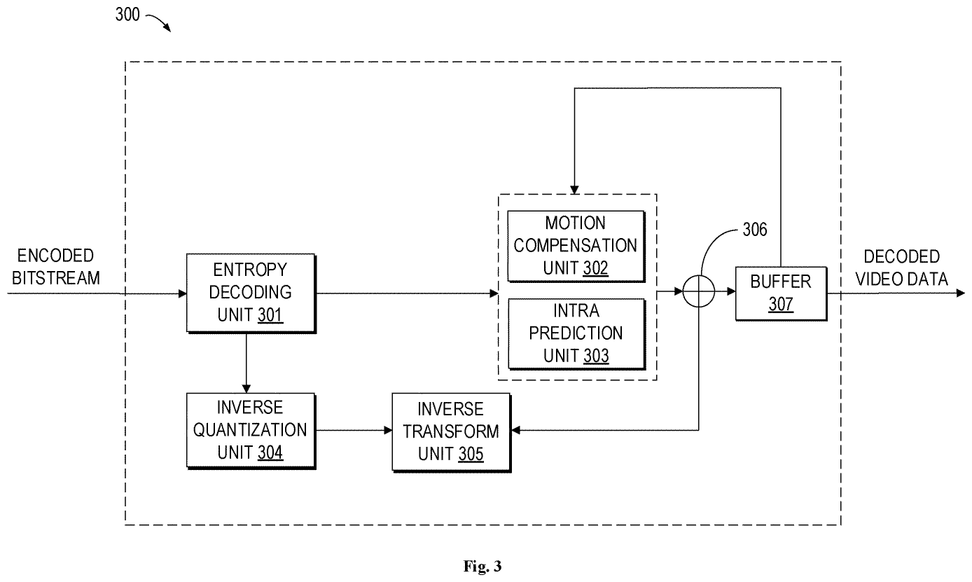

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is related to in-loop filter and other coding tools in image/video coding. The ideas may be applied individually or in various combination, to any existing video coding standard or non-standard video codec like High Efficiency Video Coding (HEVC) and Versatile Video Coding (VVC). The proposed ideas may be also applicable to future video coding standards or video codec.

### 2. ABBREVIATIONS

AVC Advanced Video Coding
CPB Coded Picture Buffer
CRA Clean Random Access
CTU Coding Tree Unit
CVS Coded Video Sequence
DPB Decoded Picture Buffer
DPS Decoding Parameter Set
GCI General Constraints Information
HEVC High Efficiency Video Coding
JEM Joint Exploration Model
MCTS Motion-Constrained Tile Sets
NAL Network Abstraction Layer
OLS Output Layer Set
PH Picture Header
PPS Picture Parameter Set
PTL Profile, Tier and Level
PU Picture Unit
RRP Reference Picture Resampling
RBSP Raw Byte Sequence Payload
SEI Supplemental Enhancement Information
SH Slice Header
SPS Sequence Parameter Set
VCL Video Coding Layer
VPS Video Parameter Set
VTM VVC Test Model
VUI Video Usability Information
VVC Versatile Video Coding
TU Transform Unit
CU Coding Unit
DF Deblocking Filter
SAO Sample Adaptive Offset
ALF Adaptive Loop Filter
CBF Coding Block Flag
QP Quantization Parameter
RDO Rate Distortion Optimization
BF Bilateral Filter
GDR Gradual Decoding Refresh

### 3. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET meeting is concurrently held once every quarter, and the new coding standard is targeting at 50% bitrate reduction as compared to HEVC. The new video coding standard was officially named as Versatile Video Coding (VVC) in the April 2018 JVET meeting, and the first version of VVC test model (VTM) was released at that time. As there are continuous effort contributing to VVC standardization, new coding techniques are being adopted to the VVC standard in every JVET meeting. The VVC working draft and test model VTM are then updated after every meeting.

ITU-T VCEG (Q6/16) and ISO/IEC MPEG (JTC 1/SC 29/WG 11) are studying the potential need for standardization of future video coding technology with a compression capability that significantly exceeds that of the current VVC standard. Such future standardization action could either take the form of extended extension(s) of VVC or an entirely new standard. The groups are working together on this exploration activity in a joint-collaboration effort known as the Joint Video Exploration Team (JVET) to evaluate compression technology designs proposed by their experts in this area. The first Exploration Experiments (EE) were established in JVET meeting during 6-15 Jan. 2021 and the reference software named as Enhanced Compression Model (ECM). The test model ECM is updated after every JVET meeting.

### 3.1. Color Space and Chroma Subsampling

Color space, also known as the color model (or color system), is an abstract mathematical model which simply describes the range of colors as tuples of numbers, typically as 3 or 4 values or color components (e.g. RGB).

Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

3.1.1.4:4:4

Each of the three Y′CbCr components have the same sample rate, thus there is no chroma subsampling. This scheme is sometimes used in high-end film scanners and cinematic postproduction.

3.1.2.4:2:2

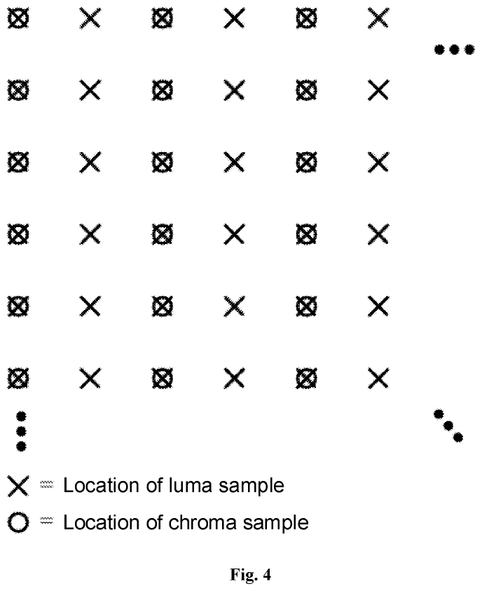

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft. FIG. 4 illustrates nominal vertical and horizontal locations of 4:2:2 luma and chroma samples in a picture.

3.1.3.4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially).

In JPEG/JFIF, H.261, and MPEG-1, Cb and Cr are sited interstitially, halfway between alternate luma samples.

In 4:2:0 DV, Cb and Cr are co-sited in the horizontal direction. In the vertical direction, they are co-sited on alternating lines.

TABLE 1
Sub WidthC and SubHeightC values derived
from chroma_format_idc and separate_colour_plane_flag

| chroma_for- | separate_col- | Chroma | | |
|---|---|---|---|---|
| mat_idc | our_plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 3.2. Coding Flow of a Typical Video Codec

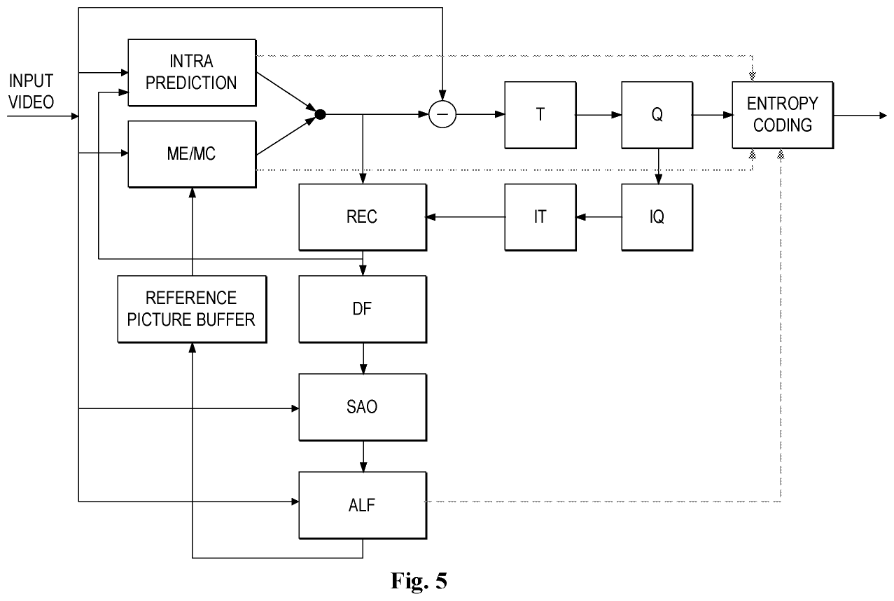

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 3.3. Definitions of Video/Coding Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains several tiles of a picture or several bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

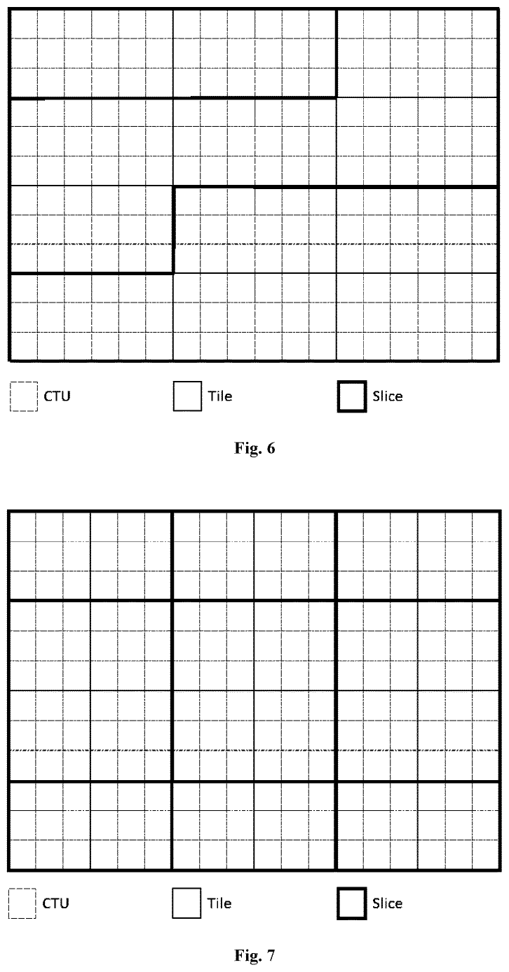

FIG. 6 shows an example of raster-scan slice partitioning of a picture, where the picture is divided into 12 tiles and 3 raster-scan slices. FIG. 6 illustrates a picture with 18 by 12 luma CTUs that is partitioned into 12 tiles and 3 raster-scan slices.

FIG. 7 in the VVC specification shows an example of rectangular slice partitioning of a picture, where the picture is divided into 24 tiles (6 tile columns and 4 tile rows) and 9 rectangular slices. FIG. 7 illustrates a picture with 18 by 12 luma CTUs that is partitioned into 24 tiles and 9 rectangular slices.

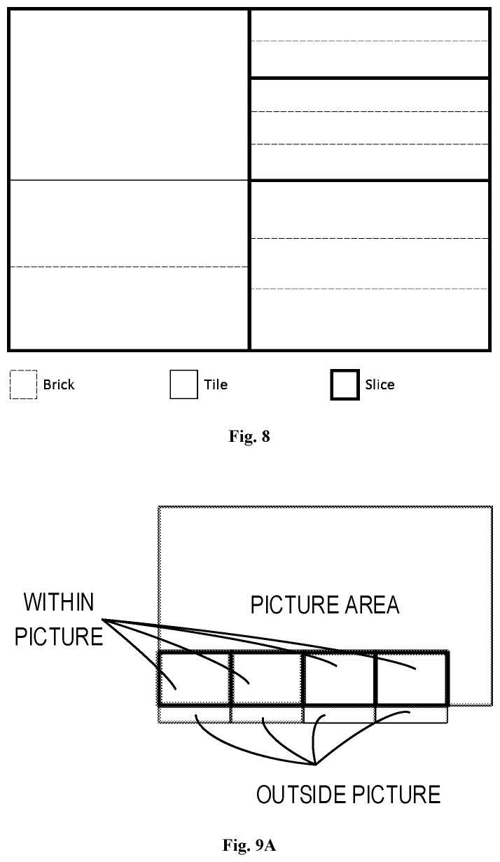

FIG. 8 in the VVC specification shows an example of a picture partitioned into tiles, bricks, and rectangular slices, where the picture is divided into 4 tiles (2 tie columns and 2 tile rows), 11 bricks (the top-left file contains 1 brick, the top-right tile contains 5 bricks, the bottom-left tile contains 2 bricks, and the bottom-right tile contain 3 bricks), and 4 rectangular slices. FIG. 8 illustrates a picture is partitioned into 4 tiles, 11 bricks, and 4 rectangular slices.

### 3.3.1. CTU/CTB Sizes

In VVC, the CTU size, signaled in SPS by the syntax element log2_ctu_size_minus2, could be as small as 4×4.

### Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i= 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log2_ctu_size_minus2 plus 2 specifies the luma coding tree block size of each CTU.

log2_min_luma_coding_block_size_minus2 plus 2 specifies the minimum luma coding block size.

The variables CtbLog2SizeY, CtbSizeY, MinCbLog2SizeY, MinCbSizeY, MinTbLog2SizeY, MaxTbLog2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$CtbLog 2 SizeY = log2\_ctu \_size \_minus2 + 2 \qquad ( 7 - 9 )$$

$$CtbSizeY = 1 ≪ CtbLog 2 SizeY \qquad ( 7 - 10 )$$

$$MinCbLog 2 SizeY = log2\_min \_luma \_coding \_block \_size \_minus2 + 2 \qquad ( 7 - 11 )$$

$$MinCbSizeY = 1 ≪ MinCbLog 2 SizeY \qquad ( 7 - 12 )$$

$$MinTbLog 2 SizeY = 2 \qquad ( 7 - 13 )$$

$$MaxTbLog 2 SizeY = 6 \qquad ( 7 - 14 )$$

$$MinTbSizeY = 1 ≪ MinTbLog 2 SizeY \qquad ( 7 - 15 )$$

$$MaxTbSizeY = 1 ≪ MaxTbLog 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthInMinCbsY = pic\_width \_in \_luma \_samples / MinCbSizeY \qquad ( 7 - 20 )$$

$$PicHeightInMinCbsY = pic\_height \_in \_luma \_samples / MinCbSizeY \qquad ( 7 - 21 )$$

$$PicSizeInMinCbsY = PicWidthInMinCbsY * PicHeightInMinCbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 3.3.2. CTUs in One Picture

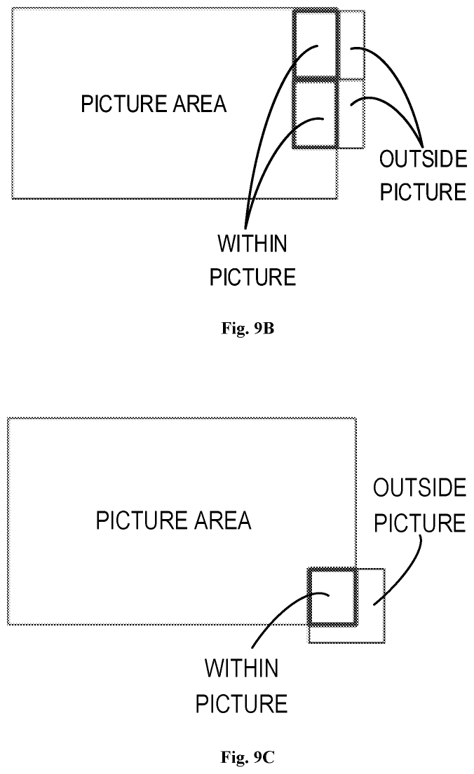

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIG. 9A to FIG. 9C, the CTB size is still equal to M×N, however, the bottom boundary/right boundary of the CTB is outside the picture. FIG. 9A-FIG. 9C illustrate examples of CTBs crossing picture borders, wherein FIG. 9A illustrates CTSs crossing the bottom picture border, FIG. 9B illustrates CTSs crossing the right picture border, and FIG. 9C illustrates CTBs crossing the right bottom picture border.

### 3.4. Intra Prediction

To capture the arbitrary edge directions presented in natural video, the number of directional intra modes is extended from 33, as used in HEVC, to 65. The extended directional modes are depicted as dotted arrows, and the planar and DC modes remain the same. These denser directional intra prediction modes apply for all block sizes and for both luma and chroma intra predictions.

Conventional angular intra prediction directions are defined from 45 degrees to −135 degrees in clockwise direction as shown in FIG. 10. FIG. 10 illustrates 67 intra prediction modes. In VTM, several conventional angular intra prediction modes are adaptively replaced with wide-angle intra prediction modes for the non-square blocks. The replaced modes are signalled using the original method and remapped to the indexes of wide angular modes after parsing. The total number of intra prediction modes is unchanged, i.e., 67, and the intra mode coding is unchanged.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 3.5. Inter Prediction

For each inter-predicted CU, motion parameters consisting of motion vectors, reference picture indices and reference picture list usage index, and extended information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and extended schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 3.6. Deblocking Filter

Deblocking filtering typical in-loop filter in video codec. In VVC, the deblocking filtering process is applied on CU boundaries, transform subblock boundaries and prediction subblock boundaries. The prediction subblock boundaries include the prediction unit boundaries introduced by the SbTMVP (Subblock based Temporal Motion Vector prediction) and affine modes, and the transform subblock boundaries include the transform unit boundaries introduced by SBT (Subblock transform) and ISP (Intra Sub-Partitions) modes and transforms due to implicit split of large CUs. As done in HEVC, the processing order of the deblocking filter is defined as horizontal filtering for vertical edges for the entire picture first, followed by vertical filtering for horizontal edges. This specific order enables either multiple horizontal filtering or vertical filtering processes to be applied in parallel threads or can still be implemented on a CTB-by-CTB basis with only a small processing latency.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

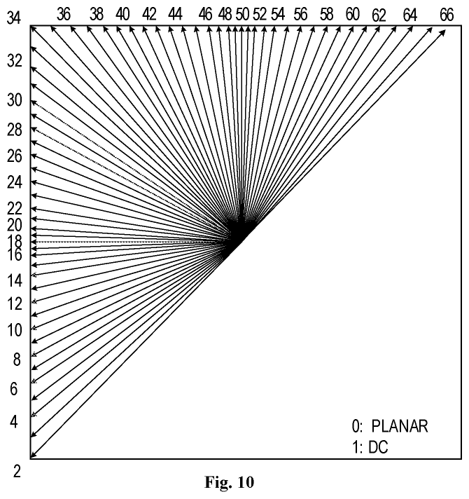

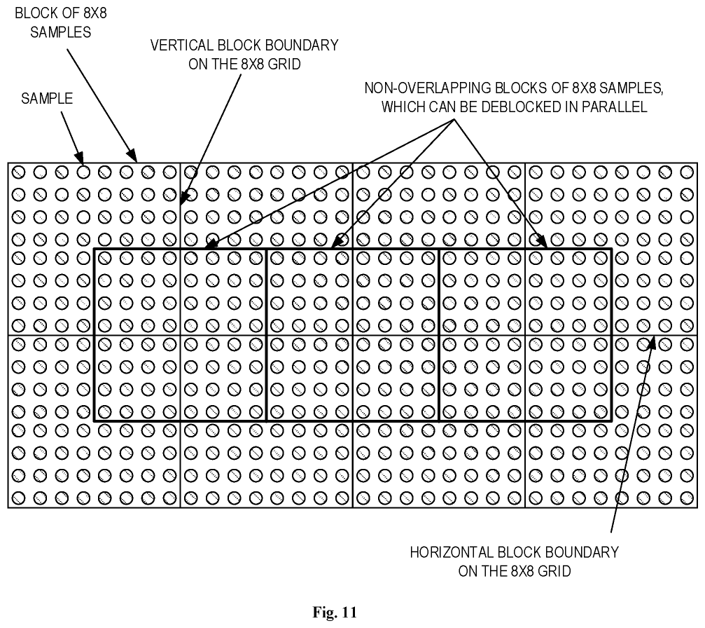

FIG. 11 illustrates an illustration of picture samples and horizontal and vertical block boundaries on the 8×8 grid, and the nonoverlapping blocks of the 8×8 samples, which can be deblocked in parallel.

### 3.6.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 3.6.2. Boundary Strength Calculation

For a transform block boundary/coding subblock boundary, if it is located in the 8×8 grid, it may be filtered and the selling of bS[xDᵢ][yDⱼ] (wherein [xDᵢ][yDⱼ] denotes the coordinate) for this edge is defined as below.

TABLE 2
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks | 1 | 1 | 1 |
| | has non-zero transform coefficients | | | |
| 3 | Reference pictures or number of MVs (1 for uni-prediction, | 1 | N/A | N/A |
| | 2 for bi-prediction) of the adjacent blocks are different | | | |
| 2 | Absolute difference between the motion vectors of | 1 | N/A | N/A |
| | same reference picture that belong to the adjacent | | | |
| | blocks is greater than or equal to one integer | | | |
| | luma sample | | | |
| 1 | Otherwise | 0 | 0 | 0 |

TABLE 3
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is different | 1 | | |
| | (e.g., one is IBC, one is inter) | | | |
| 5 | Both IBC and absolute difference between the motion | 1 | N/A | N/A |
| | vectors that belong to the adjacent blocks is greater | | | |
| | than or equal to one integer luma sample | | | |
| 4 | Reference pictures or number of MVs (1 for uni-prediction, | 1 | N/A | N/A |
| | 2 for bi-prediction) of the adjacent blocks are different | | | |
| 3 | Absolute difference between the motion vectors of same | 1 | N/A | N/A |
| | reference picture that belong to the adjacent blocks is | | | |
| | greater than or equal to one integer luma sample | | | |
| 1 | Otherwise | 0 | 0 | 0 |

### 3.6.3. Deblocking Decision for Luma Component

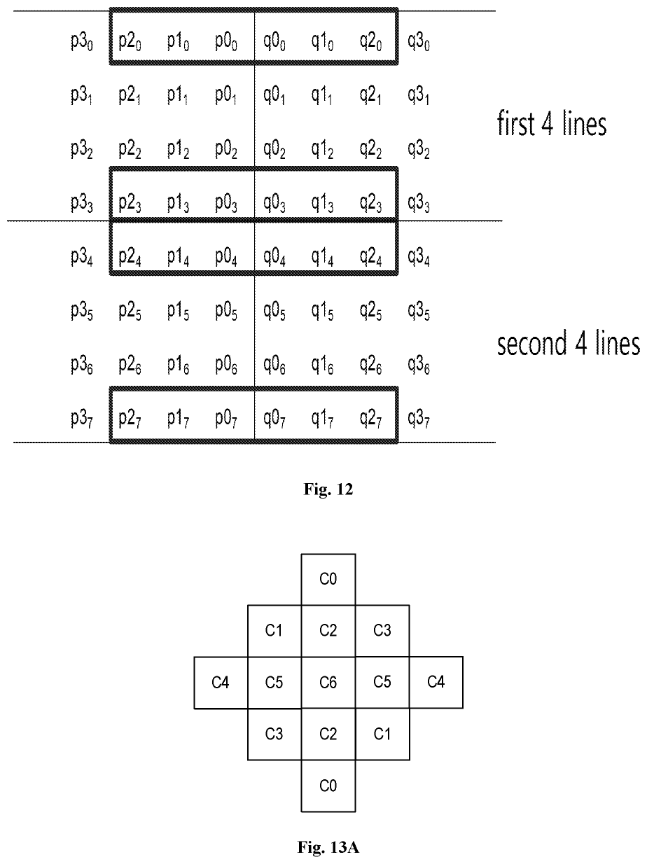

FIG. 12 illustrates pixels involved in filter on/off decision and strong/weak filter switch.

Wider-stronger luma filter is filters are used only if all the Condition1, Condition2 and Condition 3 are TRUE. The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.
bSidePisLargeBlk=((edge type is vertical and p₀ belongs to CU with width>=32) ∥(edge type is horizontal and p₀ belongs to CU with height>=32))?TRUE:FALSE
bSideQisLargeBlk=((edge type is vertical and q₀ belongs to CU with width>=32) ∥(edge type is horizontal and q₀ belongs to CU with height>=32))?TRUE:FALSE

Based on bSidePisLargeBlk and bSideQisLargeBlk, the condition 1 is defined as follows.

Condition1=(bSidePisLargeBlk ∥ bSidePisLargeBlk) ?TRUE:FALSE

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( {p5}_{0} - 2 * p {4}_{0} + p {3}_{0} ) + 1 ) ≫ 1$$

$$dp 3 = ( dp 3 + Abs ( {p5}_{3} - 2 * p {4}_{3} + p {3}_{3} ) + 1 ) ≫ 1$$

if (q side is greater than or equal to 32)

$$dq 0 = ( dq 0 + Abs ( {q5}_{0} - 2 * q {4}_{0} + {q3}_{0} ) + 1 ) ≫ 1$$

$$dq 3 = ( dq 3 + Abs ( {q5}_{3} - 2 * q {4}_{3} + {q3}_{3} ) + 1 ) ≫ 1$$

Condition2=(d<β) ?TRUE:FALSE
where d=dp0+dq0+dp3+dq3.

If Condition1 and Condition2 are valid, whether any of the blocks uses sub-blocks is further checked:

```
If (bSidePisLargeBlk)
  {
    If (mode block P == SUBBLOCKMODE)
        Sp =5
      else
        Sp =7
}
else
  Sp = 3
If (bSideQisLargeBlk)
  {
    If (mode block Q == SUBBLOCKMODE)
        Sq =5
      else
        Sq =7
    }
else
  Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1
```

As in HEVC, StrongFilterCondition=(dpq is less than (β>>2), sp₃+sq₃ is less than (3*β>>5), and Abs(p₀−q₀) is less than (5*t_{C}+1)>>1) ?TRUE:FALSE.

### 3.6.4. Stronger Deblocking Filter for Luma

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp−1 and qᵢ for j=0 to Sq−1 (pᵢ and qᵢ are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${q}_{j}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}$$

where tcPDᵢ and tcPDⱼ term is a position dependent clipping described in Section 3.6.2 and gⱼ, fᵢ, Middle_{s,t}, Pₛ and Qₛ are given below:

### 3.6.5. Deblocking Decision for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.

The second condition will be TRUE when d is less than D.

In the third condition StrongFilterCondition is derived as follows:
dpq is derived as in HEVC.
sp₃=Abs(p₃−p₀), derived as in HEVC
sq₃=Abs(q₀−q₃), derived as in HEVC

As in HEVC design, StrongFilterCondition=(dpq is less than (β>>2), sp₃+sq₃ is less than (β>>3), and Abs(p₀−q₀) is less than (5*t_{C}+1)>>1)

### 3.6.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) >> 3 \\ {p}_{1}^{′} = ( 2 * {p}_{3} + {p}_{2} + 2 * {p}_{1} + {p}_{0} + {q}_{0} + {q}_{1} + 4 ) >> 3 \\ {p}_{0}^{′} = ( {p}_{3} + {p}_{2} + {p}_{1} + 2 * {p}_{0} + {q}_{0} + {q}_{1} + {q}_{2} + 4 ) >> 3$$

The proposed chroma filter performs deblocking on a 4×4 chroma sample grid.

### 3.6.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making, position dependent threshold table is selected from two tables (i.e., Tc7 and Tc3 tabulated below) that are provided to decoder as a side information:

$$T c 7 = \{ 6 , 5 , 4 , 3 , 2 , 1 , 1 \} ; \\ Tc 3 = \{ 6 , 4 , 2 ) ; \\ tcPD = ( Sp == 3 ) ? Tc 3 : Tc 7 ; \\ tcQD = ( Sq == 3 ) ? Tc 3 : Tc 7 ;$$

For the P or Q boundaries being filtered with a short symmetrical filter, position dependent threshold of lower magnitude is applied:

$$T c 3 = \{ 3 , 2 , 1 \} ;$$

Following defining the threshold, filtered p′ᵢ and q′ᵢ sample values are clipped according to tcP and tcQ clipping values:

$${p}_{i}^{″} = Clip 3 ( {p}_{i}^{′} + tc {P}_{i} , {p}_{i}^{′} - {tcP}_{i} , {p}_{i}^{′} ) ; \\ {q}_{j}^{″} = Clip 3 ( {q}_{j}^{′} + {tcQ}_{j} , {q}_{j}^{′} - {tcQ}_{j} , {q}_{j}^{′} ) ;$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 3.6.8. Sub-block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Extendedly, the sub-block deblocking is adjusted such that that sub-block boundaries on an 8×8 grid that are close to a CU or an implicit TU boundary is restricted to modify at most two samples on each side.

Following applies to sub-block boundaries that are not aligned with the CU boundary.

```
If (mode block Q == SUBBLOCKMODE && edge !=0) {
  if (!(implicitTU && (edge == (64 / 4))))
    if (edge == 2 || edge == (orthogonalLength − 2) || edge == (56 / 4) || edge == (72 / 4))
      Sp = Sq = 2;
    else
      Sp = Sq = 3;
  else
    Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 3.7. Sample Adaptive Offset

Sample adaptive offset (SAO) is applied to the reconstructed signal after the deblocking filter by using offsets specified for each CTB by the encoder. The video encoder first makes the decision on whether or not the SAO process is to be applied for current slice. If SAO is applied for the slice, each CTB is classified as one of five SAO types as shown in Table 1. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above.

TABLE 4
Specification of SAO type

| SAO | sample adaptive offset type | Number of |
|---|---|---|
| type | to be used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

### 3.8. Adaptive Loop Filter

Adaptive loop filtering for video coding is to minimize the mean square error between original samples and decoded samples by using Wiener-based adaptive filter. The ALF is located at the last processing stage for each picture and can be regarded as a tool to catch and fix artifacts from previous stages. The suitable filter coefficients are determined by the encoder and explicitly signalled to the decoder. To achieve better coding efficiency, especially for high resolution videos, local adaptation is used for luma signals by applying different filters to different regions or blocks in a picture. In addition to filter adaptation, filter on/off control at coding tree unit (CTU) level is also helpful for improving coding efficiency. Syntax-wise, filter coefficients are sent in a picture level header called adaptation parameter set, and filter on/off flags of CTUs are interleaved at CTU level in the slice data. This syntax design not only supports picture level optimization but also achieves a low encoding latency.

### 3.8.1. Signaling of Parameters

According to ALF design in VTM, filter coefficients and clipping indices are carried in ALF APSs. An ALF APS can include up to 8 chroma filters and one luma filter set with up to 25 filters. An index is also included for each of the 25 luma classes. Classes having the same index share the same filter. By merging different classes, the num of bits required to represent the filter coefficients is reduced. The absolute value of a filter coefficient is represented using a 0^{th} order Exp-Golomb code followed by a sign bit for a non-zero coefficient. When clipping is enabled, a clipping index is also signalled for each filter coefficient using a two-bit fixed-length code. Up to 8 ALF APSs can be used by the decoder at the same time.

Filter control syntax elements of ALF in VTM include two types of information. First, ALF on/off flags are signalled at sequence, picture, slice and CTB levels. Chroma ALF can be enabled at picture and slice level only if luma ALF is enabled at the corresponding level. Second, filter usage information is signalled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signalled indicating which ALF APS or offline trained luma filter set is used. For a chroma CTB, the index indicates which filter in the referenced APS is used.

The data syntax elements of ALF associated to LUMA component in VTM are listed as follows:

| | Descriptor |
|---|---|
| alf_data( ) { | |
| alf_luma_filter_signal_flag | u(1) |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j = 0; j < 12; j++ ) | |
| alf_luma_clip_idx[ sfIdx ][ j ] | u(2) |
| } | |

alf_luma_filter_signal_flag equal to 1 specifies that a luma filter set is signalled. alf_luma_filter_signal_flag equal to 0 specifies that a luma filter set is not signalled.

alf_luma_clip_flag equal to 0 specifies that linear adaptive loop filtering is applied to the luma component. alf_luma_clip_flag equal to 1 specifies that non-linear adaptive loop filtering could be applied to the luma component.

alf_luma_num_filters_signalled_minus1 plus 1 specifies the number of adaptive loop filter classes for which luma coefficients can be signalled. The value of alf_luma_num_filters_signalled_minus1 shall be in the range of 0 to NumAlffilters−1, inclusive.

alf_luma_coeff_delta_idx[filtIdx] specifies the indices of the signalled adaptive loop filter luma coefficient deltas for the filter class indicated by filtIdx ranging from 0 to NumAlffilters−1. When alf_luma_coeff_delta_idx[filtIdx] is not present, it is inferred to be equal to 0. The length of alf_luma_coeff_delta_idx[filtIdx] is Ceil(Log2(alf_luma_num_filters_signalled_minus1+1)) bits. The value of alf_luma_coeff_delta_idx[filtIdx] shall be in the range of 0 to alf_luma_num_filters_signalled_minus1l, inclusive.

alf_luma_coeff_abs[sfIdx][j] specifies the absolute value of the j-th coefficient of the signalled luma filter indicated by sfIdx. When alf_luma_coeff_abs[sfIdx][j] is not present, it is inferred to be equal 0. The value of alf_luma_coeff_abs[sfIdx][j] shall be in the range of 0 to 128, inclusive.

alf_luma_coeff_sign[sfIdx][j] specifies the sign of the j-th luma coefficient of the filter indicated by sfIdx as follows:
If alf_luma_coeff_sign[sfIdx][j] is equal to 0, the corresponding luma filter coefficient has a positive value.
Otherwise (alf_luma_coeff_sign[sfIdx][j] is equal to 1), the corresponding luma filter coefficient has a negative value.

When af_luma_coeff_sign[sfIdx][j] is not present, it is inferred to be equal to 0. alf_luma_clip_idx[sfIdx][j] specifies the clipping index of the clipping value to use before multiplying by the j-th coefficient of the signalled luma filter indicated by sfIdx. When alf_luma_clip_idx[sfIdx][j] is not present, it is inferred to be equal to 0.

The coding tree unit syntax elements of ALF associated to LUMA component in VTM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| } | |

alf_ctb_flag[cIdx][xCtb>>CtbLog2SizeY][yCtb>>CtbLog2SizeY] equal to 1 specifies that the adaptive loop filter is applied to the coding tree block of the colour component indicated by cIdx of the coding tree unit at luma location (xCtb, yCtb). alf_ctb_flag[cIdx][xCtb>>CtbLog2SizeY][yCtb>CtbLog2SizeY] equal to 0 specifies that the adaptive loop filter is not applied to the coding tree block of the colour component indicated by cIdx of the coding tree unit at luma location (xCtb, yCtb).

When alf_ctb_flag[cIdx][xCtb>>CtbLog2SizeY][yCtb>>CtbLog2SizeY] is not present, it is inferred to be equal to 0.

alf_use_aps_flag equal to 0 specifies that one of the fixed filter sets is applied to the luma CTB. alf_use_aps_flag equal to 1 specifies that a filter set from an APS is applied to the luma CTB. When alf_use_aps_flag is not present, it is inferred to be equal to 0.

aif_luma_prev_filter_idx specifies the previous filter that is applied to the luma CTB. The value of alf_luma_prev_filter_idx shall be in a range of 0 to sh_num_alf_aps_ids_luma−1, inclusive. When alf_luma_prev_filter_idx is not present, it is inferred to be equal to 0.

The variable AlfCtbFiltSetIdxY[xCtb>>CtbLog2SizeY][yCtb>>CtbLog2SizeY] specifying the filter set index for the luma CTB at location (xCtb, yCtb) is derived as follows:
If alf_use_aps_flag is equal to 0, AlfCtbFiltSetIdxY[xCtb>>CtbLog2SizeY][yCtb>>CtbLog2SizeY] is set equal to alf_luma_fixed_filter_idx.
Otherwise, AlfCtbFiltSetIdxY[xCtb>>CtbLog2SizeY][yCtb>>CtbLog2SizeY] is set equal to 16+alf_luma_prev_filter_idx.

alf_luma_fixed_filter_idx specifies the fixed filter that is applied to the luma CTB. The value of alf_luma_fixed_filter_idx shall be in a range of 0 to 15, inclusive.

Based on the ALF design of VTM, the ALF design of ECM further introduces the concept of alternative filter sets into luma filters. The luma filters are be trained multiple alternatives/rounds based on the updated luma CTU ALF on/off decisions of each alternative/rounds. In such way, there will be multiple filter sets that associated to each training alternative and the class merging results of each filter set may be different. Each CTU could select the best filter set by RDO and the related alternative information will be signaled.

The data syntax elements of ALF associated to LUMA component in ECM are listed as follows:

| | Descriptor |
|---|---|
| alf_data( ) { | |
| alf_luma_filter_signal_flag | u(1) |
| if( alf_luma_filter_signal_flag ) { | |
| alf_luma_num_alts_minus1 | ue(v) |
| for(altIdx = 0; altIdx < alf_luma_num_alts_minus1 +1; altIdx++){ | |
| alf_luma_clip_flag[altIdx] | u(1) |
| alf_luma_num_filters_signalled_minus1[altIdx] | ue(v) |
| if(alf_luma_num_filters_signalled_minus1[altIdx] > 0){ | |
| for( filtIdx = 0; filtIdx < NumAlfFilters; filtIdx++ ) | |
| alf_luma_coeff_delta_idx[altIdx][filtIdx] | u(v) |
| } | |
| for(sfIdx = 0; sfIdx <= alf_luma_num_filters_signalled_minus1[altIdx]; sfIdx++){ | |
| for(j = 0; j < 19; j++){ | |
| alf_luma_coeff_abs[altIdx][ sfIdx ][ j ] | ue(v) |
| if( alf_luma_coeff_abs[altIdx][ sfIdx ][ j ] ) | |
| alf_luma_coeff_sign[altIdx][ sfIdx ][ j ] | u(1) |
| } | |
| } | |
| if( alf_luma_clip_flag [altIdx]) | |
| for( sfIdx = 0; sfIdx <= alf_luma_num_filters_signalled_minus1[altIdx]; | |
| sfIdx++ ) | |
| for( j = 0; j <19; j++ ) | |
| alf_luma_clip_idx[altIdx][ sfIdx ][ j ] | u(2) |
| } | |
| } | |

alf_luma_num_alts_minus1 plus 1 specifies the number of alternative filter sets for luma component. The value of alf_luma_num_alts_minus1 shall be in the range of 0 to 3, inclusive.

alf_luma_clip_flag[altIdx] equal to 0 specifies that linear adaptive loop filtering is applied to the alternative luma filter set with index altIdx. alf_luma_clip_flag[altIdx] equal to 1 specifies that non-linear adaptive loop filtering could be applied to the alternative luma filter set with index altIdx.

alf_luma_num_filters_signalled_minus1[altIdx] plus 1 specifies the number of adaptive loop filter classes for which luma coefficients can be signalled of the alternative luma filter set with index altIdx. The value of alf_luma_num_filters_signalled_minus1[altIdx] shall be in the range of 0 to NumAlfFilters−1, inclusive.

alf_luma_coeff_delta_idx[altIdx][filtIdx] specifies the indices of the signalled adaptive loop filter luma coefficient deltas for the filter class indicated by filtIdx ranging from 0 to NumAlfFilters−1 for the alternative luma filter set with index altIdx. When alf_luma_coeff_delta_idx[filtIdx][altIdx] is not present, it is inferred to be equal to 0. The length of alf_luma_coeff_delta_idx[altIdx][filtIdx] is Ceil(Log2(alf_luma_num_filters_signalled_minus1[altIdx]+1)) bits. The value of alf_luma_coeff_delta_idx[altIdx][filtIdx] shall be in the range of 0 to alf_luma_num_filters_signalled_minus1[altIdx], inclusive.

alf_luma_coeff_abs[altIdx][sfIdx][j] specifies the absolute value of the j-th coefficient of the signalled luma filter indicated by sfIdx of the alternative luma filter set with index altIdx. When alf_luma_coeff_abs[altIdx][sfIdx][j] is not present, it is inferred to be equal 0. The value of alf_luma_coeff_abs[altIdx][sfIdx][j] shall be in the range of 0 to 128, inclusive.

alf_luma_coeff_sign[altIdx][sfIdx][j] specifies the sign of the j-th luma coefficient of the filter indicated by sfIdx of the alternative luma filter set with index altIdx as follows:
If alf_luma_coeff_sign[altIdx][sfIdx][j] is equal to 0, the corresponding luma filter coefficient has a positive value.
Otherwise (alf_luma_coeff_sign[altIdx][sfIdx][j] is equal to 1), the corresponding luma filter coefficient has a negative value.

When alf_luma_coeff_sign[altIdx][sfIdx][j] is not present, it is inferred to be equal to 0.

alf_luma_clip_idx[altIdx][sfIdx][i] specifies the clipping index of the clipping value to use before multiplying by the j-th coefficient of the signalled luma filter indicated by sfIdx of the alternative luma filter set with index altIdx. When alf_luma_clip_idx[altIdx][sfIdx][j] is not present, it is inferred to be equal to 0. The coding tree unit syntax elements of ALF associated to LUMA component in ECM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alt_ctb_luma_filter_alt_idx[CtbAddrX][CtbAddrY] | ae(v) |
| alf_luma_prev_filter_idx | ae(v) |
| } else | |
| alf_luma_fixed_filter_idx | ae(v) |
| } | |

}

alf_ctb_luma_filter_alt_idx[xCtb>>CtbLog2SizeY][yCtb>>CtbLog2SizeY] specifies the index of the alternative luma filters applied to the coding tree block of the luma component, of the coding tree unit at luma location (xCtb, yCtb). When alf_ctb_luma_filter_alt_idx[xCtb>>CtbLog2SizeY][yCtb>>CtbLog2SizeY] is not present, it is inferred to be equal to zero.

### 3.8.2. Filter Shapes

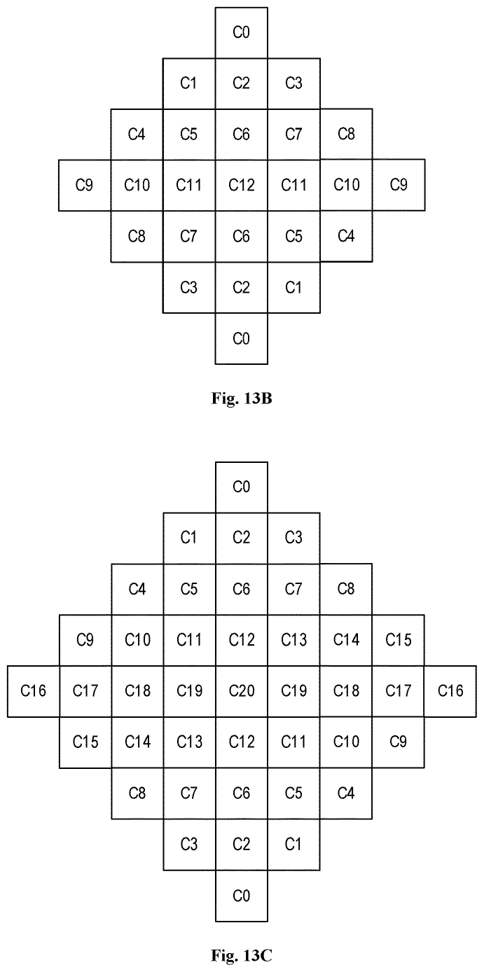

FIG. 13A-FIG. 13C illustrate filter shapes for ALF, respectively. In the JEM, up to three diamond filter shapes (as shown in FIG. 13A to FIG. 13C) can be selected for the luma component. An index is signalled at the picture level to indicate the filter shape used for the luma component. Each square represents a sample, and Ci (i being 0~6 (left), 0~12 (middle), 0~20 (right)) denotes the coefficient to be applied to the sample. For chroma components in a picture, the 5×5 diamond shape is always used. In VVC, the 7×7 diamond shape is always used for Luma while the 5×5 diamond shape is always used for Chroma.

### 3.8.3. Classification for ALF

Each 2×2 (or 4×4) block is categorized into one out of 25 classes. The classification index C is derived based on its directionality D and a quantized value of activity A, as follows:

$$C = 5 D + \hat{A} .$$

To calculate D and Â, gradients of the horizontal, vertical and two diagonal direction are first calculated using 1-D Laplacian:

$${g}_{ν} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , {g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , {g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \\ {g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

$${g}_{h , v}^{max} = max ( {g}_{h} , {g}_{ν} ) , {g}_{h , v}^{min} = min ( {g}_{h} , {g}_{ν} ) ,$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) ,$$

To derive the value of the directionality D, these values are compared against each other and with two thresholds t₁ and t₂:
Step 1. If both

$${g}_{h , v}^{max} \leq {t}_{1} \cdot {g}_{h , ν}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3.

$${g}_{h , v}^{max} > {t}_{2} \cdot {g}_{h , v}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For both chroma components in a picture, no classification method is applied, i.e. a single set of ALF coefficients is applied for each chroma component.

### 3.8.4. Geometric Transformations of Filter Coefficients

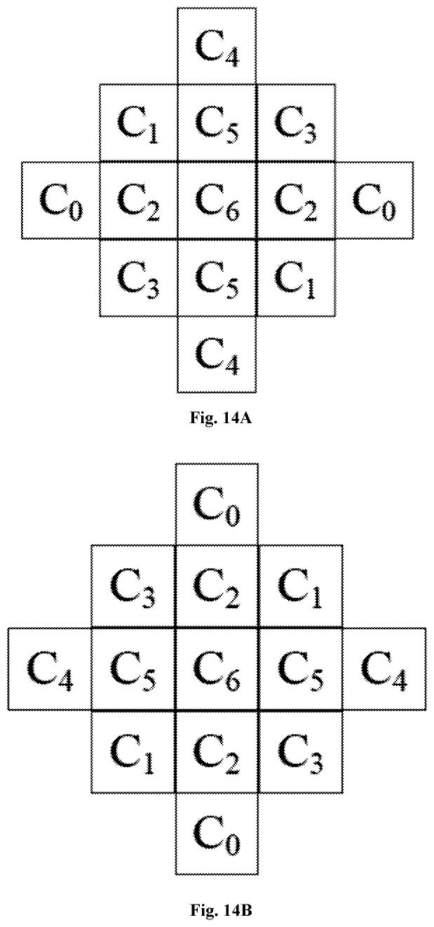

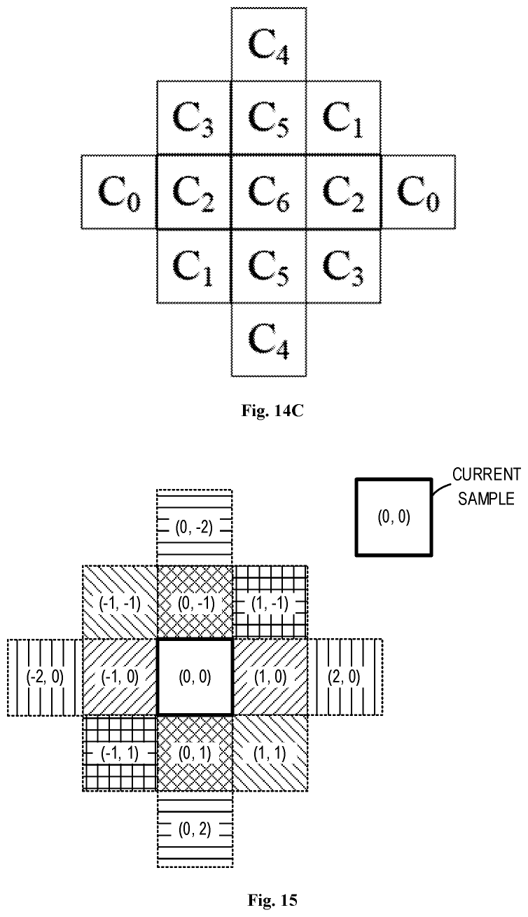

FIG. 14A-FIG. 14C illustrate relative coordinator for the 5×5 diamond filter support, respectively.

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , Vertical flip : {f}_{V} ( k , l ) = f ( k , K - l - 1 ) , Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f((k, l) depending on gradient values calculated for that block. The relationship between the transformation and the four gradients of the four directions are summarized in Table 5. FIG. 14A to FIG. 14C show the transformed coefficients for each position based on the 5×5 diamond.

TABLE 5
Mapping of the gradient calculated for
one block and the transformations.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 3.8.5. Filtering Process

At decoder side, when ALF is enabled for a block, each sample R(i, j) within the block is filtered, resulting in sample value R′(i, j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l )$$

FIG. 15 shows an example of relative coordinates used for 5×5 diamond filter support supposing the current sample's coordinate (i, j) to be (0, 0). Samples in different coordinates filled with the same color are multiplied with the same filter coefficients.

### 3.8.6. Non-Linear Filtering Reformulation

Linear filtering can be reformulated, without coding efficiency impact, in the following expression:

$$O ( x , y ) = I ( x , y ) + {\sum }_{( i , j ) \neq ( 0 , 0 )} w ( i , j ) . ( I ( x + i , y + j ) - I ( x , y ) )$$

where w(i, j) are the same filter coefficients

VVC introduces the non-linearity to make ALF more efficient by using a simple clipping function to reduce the impact of neighbor sample values (I(x+i, y+j)) when they are too different with the current sample value (I(x,y)) being filtered.

More specifically, the ALF filter is modified as follows:

$${O}^{′} ( x , y ) = I ( x , y ) + {\sum }_{( i , j ) \neq ( 0 , 0 )} w ( i , j ) . K ( I ( x + i , y + j ) - I ( x , y ) , k ( i , j ) )$$

where K(d, b)=min(b, max(−b, d)) is the clipping function, and k(i,j) are clipping parameters, which depends on the (i, j) filter coefficient. The encoder performs the optimization to find the best k(i, j).

The clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} ,$$

$$with M = {2}^{10} and N = 4$$

Similarly, the Chroma tables of clipping values is obtained according to the following formula:

$${AlfClip}_{C} = \{ round ( A . {( {( \frac{M}{A} )}^{\frac{1}{N - 1}} )}^{N - n} ) for n ∈ 1 … N ] \} ,$$

$$with M = {2}^{10} , N = 4 and A = 4$$

### 3.9. Bilateral In-loop Filter

### 3.9.1. Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{- \frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and Mis the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 3.9.2. Bilateral Filter in Video Coding

The bilateral filter in video coding is proposed as a coding tool for the VVC. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {w}_{A} + {w}_{B} + {w}_{L} + {w}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 4. PROBLEMS

The existing designs of prediction sample derivation in video coding have the following problems:
1. In current prediction sample derivation, the compression noise inside prediction sample is not well considered, which may be suboptimal for video compression.
2. In current prediction sample derivation, no filter is used to denoise, which may be suboptimal for video compression.

### 5. DETAILED SOLUTIONS

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In this disclosure, a video unit may refer to a sequence, a picture, a sub-picture, a slice, a CTU, a TU, a block, or a region. The video unit may comprise one color component or it may comprise multiple color components.
1) It is proposed that a filtering method may be applied to prediction and/or reconstruction samples in video coding.
   a. The prediction may be generated by:
      a) Intra prediction,
      b) Inter prediction,
      c) CIIP prediction,
      d) SGPM,
      e) IBC,
      f) Intra template matching,
      g) Affine prediction,
      h) Merge prediction,
      i) AMVP prediction,
      j) GPM prediction,
      k) DMVR prediction,
      l) BDOF prediction,
      m) MMVD prediction,
      n) MIP prediction,
      o) Cross-component prediction, such as CCLM or CCCM,
      p) Subblock TMVP.
   b. In one example, the filtering method may be bilateral filtering (BF).
   c. In one example, the filtering method may be deblocking filtering.
   d. In one example, at least one parameter may be signaled to determine the filtering method.
      a) In one example, the filtering method may be SAO.
      b) In one example, the filtering method may be CCSAO.
      c) In one example, the filtering method may be ALF.
      d) In one example, the filtering method may be CCALF.
   e. In one example, the filtering method may be gaussian filter.
   f. In one example, the filtering method may be Hadamard domain filter (HDF).
   g. In one example, the filtering method may be diffusion filter.
   h. In one example, the filtering method may be a low-pass filter.
   i. In one example, the filtering method may be a high-pass filter.
   j. In one example, the filtering method may be a linear filter.
   k. In one example, the filtering method may be a non-linear filter.
   l. In one example, the prediction and/or reconstruction samples may belong to a video unit.
   m. In one example, the prediction and/or reconstruction samples may belong to a CU/PU/TU.
   n. In one example, the prediction and/or reconstruction samples may belong to a picture/slice/tile.
   o. In one example, the prediction and/or reconstruction samples may belong to a block/region.
   p. In one example, a prediction sample/pixel may be filtered/modified by the proposed BF with utilization of coded/statistical information.
      a) In one example, the filtering result of the proposed BF may be generated by following formulation:

$${I}_{f i l t e r e d} = {I}_{C} + e \times [ {\sum }_{i = 0}^{i = n} μ ( {Δ}_{i} , {Ω}_{i} ) ]$$

where I_{filtered} stands for the updated/modified luma or chroma sample/pixel and I_{C} stands for the unmodified luma or chroma sample/pixel that locates at central of the filtering shape. The A (delta) denotes the difference between corresponding reference sample and unmodified central sample and the Ω (omega) denotes the sum of vertical and horizontal distance between reference sample and central sample. The n stands for the total number of samples inside the filtering shape and e stands for the strength factor. The μ(Δ,Ω) is a function for computing the filtering weight of each position in the filtering shape.
1. In one example, the function μ(Δ,Ω) may be formulated as:

$$μ ( Δ , Ω ) = ( {e}^{- \frac{{Δ}^{2}}{2 {σ}_{r}^{2}}} \times Δ ) \times \frac{{e}^{- \frac{( Ω - 1 )}{2 {σ}_{d}^{2}}}}{1 + 4 {e}^{- \frac{1}{2 {σ}_{d}^{2}}}}$$

where σ_{d} and σᵣ are two parameters for filtering.
2. In one example, the function μ(Δ,Ω) may be baked into the look-up-table.
3. In one example, different samples or different positions inside intra reference samples may use uniform parameters or look-up-table.
4. Alternatively, different samples or different positions inside intra reference samples may use different parameters or look-up-tables.
5. In one example, the parameter such as σ_{d} and σᵣ may be pre-defined, searched, determined on-the-fly or signalled in the bitstream.
   a. In one example, the parameters mentioned above may be set based on coding mode, size or other coded information of current video unit.
   b. In one example, the parameters mentioned above may be signaled from the encoder to the decoder.
6. In one example, the parameter e may be pre-defined, searched, determined on-the-fly or signalled in the bitstream.
   a. In one example, the parameter e may be set based on coding mode, size or other coded information of current video unit.
   a) In one example, the parameter e may be set based on the luma size of current video unit.
   1. In one example, the parameter e may be set based on the max(widthₗᵤₘₐ, heightₗᵤₘₐ) or min(widthₗᵤₘₐ, heightiuma).
   2. In one example, the parameter e may be set based on the widthₗᵤₘₐ×heightₗᵤₘₐ.
   b) Alternatively, the parameter e may be set based on the chroma size of current video unit.
   1. In one example, the parameter e may be set based on the max(width_{chroma}, height_{chroma}) or min(width_{chroma}, height_{chroma}).
   2. In one example, the parameter e may be set based on the width_{chroma}×height_{chroma}.
   b. In one example, the parameter e may be signaled from the encoder to the decoder.
b) In one example, the filtering process as described in above bullets may be implemented by operations on integers.
   1. For example, variables may be left-shifted and/or right-shifted before/in/after the process in keep a suitable calculation precision.
c) In one example, the classification may be applied on BF.
   1. In one example, the different BF strength may be applied based on classification results.
   a. In one example, the classification may be based on texture strength information.
   b. In one example, the classification may be based on band information.
   c. In one example, the classification may be based on variance information.
   2. In one example, the different BF strength may be applied based on block size/dimensions.
   3. In one example, the different BF strength may be applied based on block shape.
   4. In one example, the different BF strength may be applied based on coding mode.
   5. In one example, the different BF strength may be applied based on color component.
   a. In one example, the classification may be applied for luma component but not for chroma components.
q. In one example, a prediction sample/pixel may be filtered/modified by the proposed Hadamard domain filter with utilization of coded/statistical information.
   a) In one example, the filtered sample value may be denoted as “the output of HDF”. For example, in the procedure described as following formulation, F(i,σ) is denoted as “the output of HDF”, R is Hadamard transform.

$$F ( i , σ ) = \{ \begin{matrix}R ( i ) , Abs ( R ( i ) ) > THR \\ LUT ( R ( i ) , σ ) , R ( i ) > 0 \\ - LUT ( R ( i ) , σ ) , R ( i ) \leq 0\end{matrix} LUT ( R ( i ) , σ ) = \frac{{R ( i )}^{3}}{{R ( i )}^{2} + {σ}^{2}} .$$

b) In one example, the parameter a may be pre-defined/derived/signaled.
   1. In one example, the parameter a may be pre-defined based on block size/dimensions.
   2. In one example, the parameter a may be pre-defined based on block shape.
   3. In one example, the parameter a may be pre-defined based on coding mode.
   4. In one example, the parameter a may be signaled from encoder.
   5. In one example, the parameter a may be derived at derived at decoder.
c) In one example, the classification may be applied on HDF.
   1. In one example, the different HDF strength may be applied based on classification results.
   a. In one example, the classification may be based on texture strength information.
   b. In one example, the classification may be based on band information.
   c. In one example, the classification may be based on variance information.
   2. In one example, the different HDF strength may be applied based on block size/dimensions.
   3. In one example, the different HDF strength may be applied based on block shape.
   4. In one example, the different HDF strength may be applied based on coding mode.
   5. In one example, the different HDF strength may be applied based on color component.
   a. In one example, the classification may be applied for luma component but not for chroma components.
r. In one example, a prediction sample/pixel may be filtered/modified by the proposed low-pass smooth filter with utilization of coded/statistical information.
   a) In one example, the filtered sample/pixel value may be filtered by using spatial neighboring samples only in left and top neighbor as in following formulation, where W1, W2, W3 denote the weighting factors (e.g., W1=1, W2=1, W3=6). (x,y) is the coordinates of current prediction samples relative to the above left corner sample. P(x,y) is the filtered prediction sample, L is the horizontal neighboring samples (row that above the top row of current block), A is the vertical neighboring samples (column that left to the left column of current block) and Pred(x,y) is the original prediction samples.

$$P ( x , y ) = ( W 1 * L ( - 1 , y ) + W 2 * A ( x , - 1 ) + W 3 * pred ( x , y ) + K ) ≫ N .$$

b) In one example, the filtered sample/pixel value may be filtered by using spatial neighboring samples only in left and top neighbor as in following formulation, where W1, W2, W3 denote the weighting factors (e.g., W1=1, W2=1, W3=1, W4=1, W5=12). (x,y) is the coordinates of current prediction samples relative to the above left corner sample. P(x,y) is the filtered prediction sample, L is the horizontal neighboring samples (row that above the top row of current block), A is the vertical neighboring samples (column that left to the left column of current block) and Pred(x,y) is the original prediction samples.

$$P ( x , y ) = ( W 1 * L ( - 1 , y ) + W 2 * L ( - 2 , y ) + W 3 * A ( x , - 1 ) + W 4 * A ( x , - 2 ) + W 5 * pred ( x , y ) + K ) ≫ N .$$

c) In one example, the weighting values may be pre-defined/derived/signaled.
   1. In one example, the weighting values may be pre-defined based on block size/dimensions.
   2. In one example, the weighting values may be pre-defined, or signaled, or derived.
   3. In one example, the weighting values may be based on coding information.
   a. In one example, the coding information may refer to block size/dimensions/shape.
   b. In one example, the coding information may refer to coding mode.
d) In one example, the classification may be applied on low-pass smooth filter.
   1. In one example, the different strength may be applied based on classification results.
   a. In one example, the classification may be based on texture strength information.
   b. In one example, the classification may be based on band information.
   c. In one example, the classification may be based on variance information.
   2. In one example, the different strength may be applied based on block size/dimensions.
   3. In one example, the different strength may be applied based on block shape.
   4. In one example, the different strength may be applied based on coding mode.
s. In one example, a prediction sample/pixel may be filtered/modified by the proposed diffusion filter with utilization of coded/statistical information.
   a) In one example, the diffusion filter may be design as following formulation.

$$h = \frac{1}{4 k} [ \begin{matrix}0 & k & 0 \\ k & 0 & k \\ 0 & k & 0\end{matrix} ] .$$

The filtered prediction uₙ is calculated by correlating n times the prediction signal pred with the filter mask h, i.e., by calculating:

$${u}_{n} = \underbrace{h * … * h}_{n times} * pre d .$$

Here * denotes the application of the filter mask to the block.
b) In one example, the parameters of diffusion filter may be pre-defined/derived/signaled.
   1. In one example, the parameters of diffusion filter may be pre-defined based on block size/dimensions.
   2. In one example, the parameters of diffusion filter may be pre-defined based on block shape.
   3. In one example, the parameters of diffusion filter may be pre-defined based on coding mode.
   4. In one example, the parameters of diffusion filter may be signaled from encoder.
   5. In one example, the parameters of diffusion filter may be derived at derived at decoder.
c) In one example, the classification may be applied on diffusion filter.
   1. In one example, the different diffusion filter strength may be applied based on classification results.
   a. In one example, the classification may be based on texture strength information.
   b. In one example, the classification may be based on band information.
   c. In one example, the classification may be based on variance information.
   2. In one example, the different diffusion filter strength may be applied based on block size/dimensions.
   3. In one example, the different diffusion filter strength may be applied based on block shape.
   4. In one example, the different diffusion filter strength may be applied based on coding mode.
2) It is proposed to apply a filtering method to the intra prediction samples before they are used to generate intra reconstruction.
   a. It is proposed to apply bilateral filter to prediction samples of regular intra modes.
      a) In one example, the proposed method may be applied to an angular based Luma intra mode.
      b) In one example, the proposed method may be applied to a wide-angle based Luma intra mode.
      c) In one example, the proposed method may be applied to any other regular Luma intra mode.
      d) In one example, the proposed method may be applied to an angular based Chroma intra mode.
      e) In one example, the proposed method may be applied to a wide-angle based Chroma intra mode.
      f) In one example, the proposed method may be applied to any other regular Chroma intra mode.
   b. It is proposed to apply bilateral filter to prediction samples of non-regular intra modes.
      a) In one example, the proposed method may be applied to a Luma DIMD mode.
      b) In one example, the proposed method may be applied to a Luma TIMD mode.
      c) In one example, the proposed method may be applied to a Luma SGPM mode.
      d) In one example, the proposed method may be applied to a Luma MRL/TMRL mode.
      e) In one example, the proposed method may be applied to a Luma ISP mode.
      f) In one example, the proposed method may be applied to a Luma fusion based mode.
      g) In one example, the proposed method may be applied to a Luma template matching based mode.
      h) In one example, the proposed method may be applied to any other Luma non-regular mode.
      i) In one example, the proposed method may be applied to a Chroma DIMD mode.
      j) In one example, the proposed method may be applied to a Chroma TIMD mode.
      k) In one example, the proposed method may be applied to a Chroma SGPM mode.
      l) In one example, the proposed method may be applied to a Chroma MRL/TMRL mode.
      m) In one example, the proposed method may be applied to a Chroma ISP mode.
      n) In one example, the proposed method may be applied to a Chroma fusion based mode.
      o) In one example, the proposed method may be applied to a Chroma template matching based mode.
      p) In one example, the proposed method may be applied to an Intra-CCCM mode.
      q) In one example, the proposed method may be applied to a cross component prediction (CCP) mode.
         1. Such as, CCLM, MMLM, CCCM, GLM, or their variants.
      r) In one example, the proposed method may be applied to any other Chroma non-regular mode.
3) It is proposed to apply a filtering method to the IBC prediction samples before they are used to generate IBC reconstruction.
   a. In one example, the proposed method may be applied to a Luma related IBC mode.
   b. In one example, the proposed method may be applied to a Chroma related IBC mode.
   c. In one example, the proposed method may be applied to a RR-IBC mode.
   d. In one example, the proposed method may be applied to an IBC-Merge mode.
   e. In one example, the proposed method may be applied to an IBC-AMVP mode.
   f. In one example, the proposed method may be applied to an IBC-TM mode.
   g. In one example, the proposed method may be applied to an IBC-CIIP mode.
   h. In one example, the proposed method may be applied to an IBC-GPM mode.
   i. In one example, the proposed method may be applied to an IBC-LIC mode.
   j. In one example, the proposed method may be applied to a Bi-Predictive IBC-GPM mode.
   k. In one example, the proposed method may be applied to a Bi-Predictive IBC mode.
   l. In one example, the proposed method may be applied to a DBV mode.
   m. In one example, the proposed method may be applied to any other IBC related mode.
4) It is proposed to apply a filtering method to the Intra-TMP prediction samples before they are used to generate Intra-TMP reconstruction.
   a. In one example, the proposed method may be applied to a Luma related Intra-TMP mode.
   b. In one example, the proposed method may be applied to a Chroma related Intra-TMP mode.
   c. In one example, the proposed method may be applied to an Intra-TMP fusion related mode.
5) It is proposed to apply a filtering method to the inter prediction samples before they are used to generate inter reconstruction.
   a. In one example, the proposed method may be applied to a Luma related inter mode.
   b. In one example, the proposed method may be applied to a Chroma related inter mode.
   c. In one example, the proposed method may be applied to a uni-predictive inter mode.
   d. In one example, the proposed method may be applied to a bi-predictive inter mode.
   e. In one example, the proposed method may be applied to an inter MERGE mode.
   f. In one example, the proposed method may be applied to an inter AMVP mode.
   g. In one example, the proposed method may be applied to an AMVP-MERGE mode.
   h. In one example, the proposed method may be applied to a CIIP mode.
   i. In one example, the proposed method may be applied to a LIC mode.
   j. In one example, the proposed method may be applied to a BDOF mode.
   k. In one example, the proposed method may be applied to an AFFINE mode.
   l. In one example, the proposed method may be applied to a DMVR mode.
   m. In one example, the proposed method may be applied to a MHP mode.
   n. In one example, the proposed method may be applied to an OBMC mode.
   o. In one example, the proposed method may be applied to a GPM mode.
   p. In one example, the proposed method may be applied to an Inter-CCCM mode.
   q. In one example, the proposed method may be applied to a BCW mode.
   r. In one example, the proposed method may be applied to a template matching based inter mode.
   s. In one example, the proposed method may be applied to any other inter related mode.
6) It is proposed to apply a filtering method to different color components of prediction samples, in different ways or in the same way.
   a. The same filtering methods may be applied to different color components.
   b. Different filtering methods may be applied to different color components.
   c. In one example, the proposed method may be applied to a Luma related intra mode.
   d. In one example, the proposed method may be applied to a Chroma related intra mode.
   e. In one example, the proposed method may be applied to a Cross-Component related intra mode.
   f. In one example, the proposed method may be jointly applied to Luma and Chroma related intra mode.
   g. In one example, the proposed method may be applied to a fusion based intra mode.
   h. In one example, the proposed method may be applied to a RGB related intra mode.
7) It is proposed to apply a filtering method to different coding areas of prediction.
   a. In one example, the proposed method may be applied to a CU.
   b. In one example, the proposed method may be applied to a PU.
   c. In one example, the proposed method may be applied to a TU.
   d. In one example, the proposed method may be applied to a CTU.
   e. In one example, the proposed method may be applied to a CTU row.
   f. In one example, the proposed method may be applied to a slice.
   g. In one example, the proposed method may be applied to a tile.
   h. In one example, the proposed method may be applied to a picture.
   i. In one example, the proposed method may be applied to any other coding unit/area/block.
8) It is proposed to conditional apply a filtering method to prediction samples,
   a. Whether to and/or how to apply a filtering method may depend on a condition.
   b. In one example, the condition may be the type of prediction.
   c. In one example, the condition may be the color format and/or color component.
   d. In one example, the condition may be block size.
      a) In one example, the proposed method may be applied when width/height of current block is greater than a threshold.
      b) In one example, the proposed method may be applied when width/height of current block is less than a threshold.
      c) In one example, the proposed method may be applied when total sample number of current block is greater than a threshold.
      d) In one example, the proposed method may be applied when total sample number of current block is less than a threshold.
   e. In one example, the condition may be prediction sample number of current block.
      a) In one example, the proposed method may be applied when prediction sample number of current block is greater than a threshold.
      b) In one example, the proposed method may be applied when prediction sample number of current block is less than a threshold.
   f. In one example, the condition may be picture/slice/tile size.
      a) In one example, the proposed method may be applied when width/height of current picture/slice/tile is greater than a threshold.
      b) In one example, the proposed method may be applied when width/height of current picture/slice/tile is less than a threshold.
      c) In one example, the proposed method may be applied when total sample number of current picture/slice/tile is greater than a threshold.
      d) In one example, the proposed method may be applied when total sample number of current picture/slice/tile is less than a threshold.
   g. In one example, the condition may be texture strength related information.
      a) In one example, the proposed method may be applied when variance of prediction samples is greater than a threshold.
      b) In one example, the proposed method may be applied when variance of prediction samples is less than a threshold.
      c) In one example, the proposed method may be applied when gradient of prediction samples is greater than a threshold.
      d) In one example, the proposed method may be applied when gradient of prediction samples is less than a threshold.
      e) In one example, the proposed method may be applied when valid band number of prediction samples is greater than a threshold.
      f) In one example, the proposed method may be applied when valid band number of prediction samples is less than a threshold.
      g) In one example, the proposed method may be applied when other texture related info of prediction samples is greater than a threshold.
      h) In one example, the proposed method may be applied when other texture related info of prediction samples is less than a threshold.
   h. In one example, the condition may be template information.
      a) In one example, the proposed method may be applied when template cost of current block is greater than a threshold.
      b) In one example, the proposed method may be applied when template cost of current block is less than a threshold.
   i. In one example, the condition may be coding mode info of neighbor blocks.
      a) In one example, the proposed method may be applied when coding mode of neighbor block is intra related mode.
      b) In one example, the proposed method may be applied when coding mode of neighbor block is inter/IBC/IntraTMP related mode.
   j. In one example, the above mentioned conditions may be used independently.
   k. In one example, the above mentioned conditions may be used jointly.
9) It is proposed that the padding method may be applied to prediction samples before doing filtering.
   a. In one example, the mirrored padding may be applied.
   b. In one example, the duplicated padding may be applied.
   c. In one example, the reconstructed sample from neighbor blocks may be used for filtering boundary prediction samples of current block.
   d. In one example, the reconstructed sample from neighbor blocks may be used for padding.
   e. In one example, the prediction sample from current block may be used for padding.
10) In one example, a first syntax element (SE) may be signaled to indicate whether the proposed method is applied or not.
   a. In one example, the SE may be a flag.
   b. In one example, the SE may be coded with at least one context model.
   c. In one example, the SE may be bypass coded.
   d. In one example, the SE is coded only if the current block is coded with a specific mode, such as angular based intra mode.
   e. In one example, the SE is coded only if the current block is coded with a specific mode, such as regular inter mode.
   f. In one example, the SE may be coded conditionally.
      a) In one example, the SE may be coded for one or more specific block sizes.
      b) In one example, the SE may be coded for one or more specific block shapes.
      c) In one example, the SE may be coded for one or more specific color components.
   g. In one example, the SE may be signaled for a PB/TB/CB/PU/TU/CU/VPDU/CTU/CTU row/slice/tile/sub-picture.
11) In one example, the disclosed methods may be used in post-processing and/or pre-processing.
12) In one example, the above-mentioned methods may be used jointly.
13) Alternatively, the above-mentioned methods may be used individually.
14) In one example, the proposed/described model parameter inheritance method may be applied to any in-loop filtering tools, prediction tools, pre-processing, or post-processing filtering method in video coding.
15) In above examples, the video unit may refer to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.
16) Whether to and/or how to apply the disclosed methods above may be signalled in a bitstream.
   a. In one example, they may be signalled at sequence level/group of pictures level/picture level/slice level/tile group level, such as in sequence header/picture header/SPS/VPS/DPS/DCI/PPS/APS/slice header/tile group header.
   b. In one example, they may be signalled at PB/TB/CB/PU/TU/CU/VPDU/CTU/CTU row/slice/tile/sub-picture/other kinds of region contain more than one sample or pixel.
17) Whether to and/or how to apply the disclosed methods above may be dependent on coded information, such as block size, colour format, single/dual tree partitioning, colour component, slice/picture type.

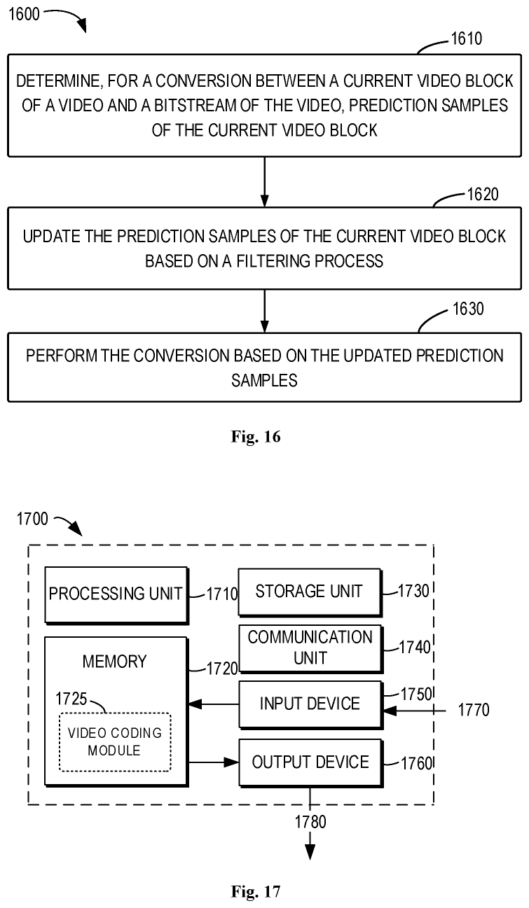

FIG. 16 illustrates a flowchart of a method 1600 for video processing in accordance with embodiments of the present disclosure. The method 1600 is implemented during a conversion between a video unit or a video block of a video and a bitstream of the video.

At block 1610, for a conversion between a current video block of a video and a bitstream of the video, prediction samples of the current video block are determined.

At block 1620, the prediction samples of the current video block are updated based on a filtering process. That is, the filtering process (also referred to as a “filter” or “filtering”) is applied to the prediction samples to update the prediction samples.

At block 1630, the conversion is performed based on the updated prediction samples.

The method 1600 enables filtering prediction samples in video coding. By filtering the prediction sample, the compression noise inside the prediction samples may be reduced. The video coding such as video compression can be enhanced.

In some embodiments, the prediction samples are determined based on at least one of: an intra prediction mode, an inter prediction mode, a combined inter and intra prediction (CIIP) prediction mode, a spatial geometric partitioning mode (SGPM), an intra block copy (IBC) mode, an intra template matching mode, an affine prediction mode, a merge prediction mode, an advanced motion vector prediction (AMVP) mode, a geometric partitioning mode (GPM) prediction mode, a decoder-side motion vector refinement (DMVR) prediction mode, a bi-directional optical flow (BDOF) prediction mode, a merge mode with motion vector difference (MMVD) prediction, a matrix based intra prediction (MIP) mode, a cross-component prediction mode, or a subblock-based temporal motion vector prediction (SbTMVP) mode.

In some embodiments, the filtering process comprises at least one of: a bilateral filter (BF), a deblocking filter, a Gaussian filter, a Hadamard domain filter (HDF), a diffusion filter, a low-pass filter, a high-pass filter, a linear filter, or a non-linear filter.

In some embodiments, at least one parameter is included in the bitstream to determine the filtering process, the filtering process comprising at least one of: a sample-adaptive offset (SAO), a cross-component sample-adaptive offset (CC-SAO), an adaptive loop filter (ALF), or a cross-component adaptive loop filter (CC-ALF).

In some embodiments, the filtering process or a further filtering process is applied to reconstruction samples (also referred to as reconstructed samples) of the current video block. For example, a same filtering process may be applied to both the prediction samples and the reconstruction samples. For another example, different filtering processes may be applied to the prediction samples and the reconstruction samples.

In some embodiments, the prediction samples and the reconstruction samples are included in one of: a video unit, a coding unit (CU), a prediction unit (PU), a transform unit (TU), a picture, a slice, a tile, a block, or a region.

In some embodiments, a prediction sample of the prediction samples is updated by a bilateral filter with coded information or statistical information.

In some embodiments, a value of the prediction sample is updated as follows:

$${I}_{f i l t e r e d} = {I}_{C} + e \times [ {\sum }_{i = 0}^{i = n} μ ( {Δ}_{i} , {Ω}_{i} ) ] ,$$

where I_{C} represents the value of the prediction sample locating at a centre of a filtering shape of the filtering process, the prediction sample comprising an luma sample or a chroma sample, I_{filtered} represents a value of the updated prediction sample updated by the bilateral filter, the updated prediction sample comprising an updated luma sample or an updated chroma sample, Δᵢ represents a difference associated with an i-th prediction sample of prediction samples in the filtering shape between a corresponding reference sample and the prediction sample locating at the centre of the filtering shape, ψᵢ represents a sum of a vertical distance and a horizontal distance associated with the i-th prediction sample between the reference sample and the prediction sample locating at the centre of the filtering shape, n represents the number of prediction samples in the filtering shape, e represents a strength factor, and μ( ) represents a function for determining a filtering weight of each position in the filtering shape.

In some embodiments, μ( ) is as follows:

$$μ ( Δ , Ω ) = ( {e}^{- \frac{{Δ}^{2}}{2 {σ}_{r}^{2}}} \times Δ ) \times \frac{{e}^{- \frac{( Ω - 1 )}{2 {σ}_{d}^{2}}}}{1 + 4 {e}^{- \frac{1}{2 {σ}_{d}^{2}}}} ,$$

where σ_{d} and σᵣ represents two parameters for the filtering process, A represents a difference between the corresponding reference sample and the prediction sample locating at the centre of the filtering shape, and (1 represents the sum of the vertical distance and the horizontal distance between the reference sample and the prediction sample locating at the centre of the filtering shape.

In some embodiments, μ( ) is added into a look-up table.

In some embodiments, same parameters or look-up table of the bilateral filter are used for different prediction samples or different positions in an intra prediction of the current video block.

In some embodiments, different parameters or look-up tables of the bilateral filter are used for different prediction samples or different positions in an intra prediction of the current video block.

In some embodiments, parameters of the bilateral filter are predefined, searched in a look-up table, determined on-the-fly, or included in the bitstream.

In some embodiments, the parameters of the bilateral filter are determined based on at least one of the followings of the current video block: a coding mode, a size, or coded information.

In some embodiments, the parameters of the bilateral filter are indicated in the bitstream from an encoder to a decoder.

In some embodiments, the parameters of the bilateral filter comprise the strength factor.

In some embodiments, the strength factor is determined based on at least one of the followings of the current video block: a coding mode, a size, or coded information.

In some embodiments, the strength factor is determined based on a luma size of the current video block.

In some embodiments, the strength factor is determined based on max(widthₗᵤₘₐ, heightₗᵤₘₐ) or min(widthₗᵤₘₐ, heightₗᵤₘₐ), widthₗᵤₘₐ representing a luma width of the current video block, and heightₗᵤₘₐ representing a luma height of the current video block.

In some embodiments, the strength factor is determined based on widthₗᵤₘₐ×heightₗᵤₘₐ, widthₗᵤₘₐ representing a luma width of the current video block, and heightₗᵤₘₐ representing a luma height of the current video block.

In some embodiments, the strength factor is determined based on a chroma size of the current video block.

In some embodiments, the strength factor is determined based on max(width_{chroma}, height_{chroma}) or min(width_{chroma}, height_{chroma}), width_{chroma} representing a chroma width of the current video block, and height_{chromaa} representing a chroma height of the current video block.

In some embodiments, the strength factor is determined based on width_{chroma}×height_{chroma}, width_{chroma} representing a chroma width of the current video block, and height_{chroma} representing a chroma height of the current video block.

In some embodiments, the strength factor is included in the bitstream from an encoder to a decoder.

In some embodiments, the filtering process is applied by operations on integers.

In some embodiments, variables used in the filtering process are left-shifted and/or right-shifted before the filtering process, in the filtering process, or after the filtering process.

In some embodiments, a classification of prediction samples is applied for the bilateral filter.

In some embodiments, the classification is applied based on at least one of: texture strength information, band information, or variance information.

In some embodiments, the strength factor of the bilateral filter is applied based on at least one of: a result of the classification, a size of the current video block, a shape of the current video block, a coding mode of the current video block, or a color component of the current video block.

In some embodiments, the classification is applied for a luma component of the current video block and not applied for chroma components of the current video block.

In some embodiments, a prediction sample of the prediction samples is updated by an HDF with coded information or statistical information.

In some embodiments, a value of the updated prediction sample is determined as follows:

$$F ( i , σ ) = \{ \begin{matrix}R ( i ) , Abs ( R ( i ) ) > THR \\ LUT ( R ( i ) , σ ) , R ( i ) > 0 \\ - LUT ( R ( i ) , σ ) , R ( i ) \leq 0\end{matrix} ,$$

wherein, F(i,σ) represents an output of the HDF that is considered as the value of an i-th prediction sample, σ represents a parameter, R(i) represents a Hadamard transform associated with the i-th prediction sample, THR represents a threshold, Abs( ) represents a function for determining an absolute value, and LUT( ) represents a function represents an output of the HDF that is considered as the value of an i-th prediction sample, represents a parameter, represents a Hadamard transform associated with the i-th prediction sample, represents a threshold, Abs( ) represents a function for determining an absolute value, and represents a function.

In some embodiments, LUT( ) is as follows:

$$LUT ( R ( i ) , σ ) = \frac{{R ( i )}^{3}}{{R ( i )}^{2} + {σ}^{2}} ,$$

wherein R(i) represents a Hadamard transform associated with the i-th prediction sample.

In some embodiments, σ is predefined, derived, or included in the bitstream.

In some embodiments, σ is predefined based on at least one of the followings of the current video block: a size, a shape, or a coding mode.

In some embodiments, σ is indicated in the bitstream from an encoder.

In some embodiments, σ is derived at a decoder.

In some embodiments, a classification of prediction samples is applied for the HDF.

In some embodiments, the classification is applied based on at least one of: texture strength information, band information, or variance information.

In some embodiments, a strength factor of the HDF is applied based on at least one of: a result of the classification, a size of the current video block, a shape of the current video block, a coding mode of the current video block, or a color component of the current video block.

In some embodiments, the classification is applied for a luma component of the current video block and not applied for chroma components of the current video block.

In some embodiments, a prediction sample of the prediction samples is updated by a low-pass smooth filter with coded information or statistical information.

In some embodiments, a value of the updated prediction sample is determined by using neighbouring samples left and above to the current video block as follows: P(x,y)=(W1*L(−1,y)+W2*A(x,−1)+W3*pred(x,y)+K)>>N, wherein (x,y) representing a coordinate of the prediction sample relative to an above left corner sample of the current video block, pred(x,y) represents an original value of the prediction sample, P(x,y) represents the value of the updated prediction sample, W1, W2, and W3 represent weighting factors, L(−1,y) represents a value of a neighbouring sample left to the current video block, A(x,−1) represents a value of a neighbouring sample above to the current video block, >> represents a right shift operation, and K and N are parameters.

In some embodiments, W1 is 1, W2 is 1, and W3 is 6.

In some embodiments, a value of the updated prediction sample is determined by using neighbouring samples left and above to the current video block as follows: P(x,y)=(W1*L(−1,y)+W2*L(−2,y)+W3*A(x,−1)+W4*A(x,−2)+W5*pred(x,y)+K)>>N, wherein (x,y) representing a coordinate of the prediction sample relative to an above left corner sample of the current video block, pred(x,y) represents an original value of the updated prediction sample, P(x,y) represents the value of the updated prediction sample, W1, W2, W3, W4, and W5 represent weighting factors, L(−1,y) and L(−2,y) represent values of neighbouring samples left to the current video block, A(x,−1) and A(x,−2) represent values of neighbouring samples above to the current video block, >> represents a right shift operation, and K and N are parameters.

In some embodiments, W1 is 1, W2 is 1, W3 is 1, W4 is 1, and W5 is 12.

In some embodiments, the weighting factors are predefined based on a size of the current video block.

In some embodiments, the weighting factors are predefined, derived, or included in the bitstream.

In some embodiments, the weighting factors are determined based on coding information.

In some embodiments, the coding information comprises at least one of: a size of the current video block, a shape of the current video block, or a coding mode of the current video block.

In some embodiments, a classification of prediction samples is applied for the low-pass smooth filter.

In some embodiments, strength of the low-pass smooth filter is applied based on at least one of: a result of the classification, a size of the current video block, a shape of the current video block, or a coding mode of the current video block.

In some embodiments, the classification is applied based on at least one of: texture strength information, band information, or variance information.

In some embodiments, the prediction samples are updated by a diffusion filter with coded information or statistical information.

In some embodiments, the prediction samples are updated by correlating the prediction samples for n times as follows:

$${u}_{n} = {\underbrace{h * … * h}}_{n times} * pred ,$$

wherein pred represents the prediction samples, uₙ represents the updated prediction samples, h represents the diffusion filter, * represents applying the diffusion filter to the current video block, and n represents a first parameter of the diffusion filter, n being an integer.

In some embodiments, h is as follows:

$$h = \frac{1}{4 k} [ \begin{matrix}0 & k & 0 \\ k & 0 & k \\ 0 & k & 0\end{matrix} ] ,$$

wherein k represents a second parameter of the diffusion filter.

In some embodiments, the first and second parameters are predefined, derived or included in the bitstream.

In some embodiments, the first and second parameters are predefined based on at least one of: a size of the current video block, a shape of the current video block, or a coding mode of the current video block.

In some embodiments, the first and second parameters are indicated in the bitstream from an encoder.

In some embodiments, the first and second parameters are derived at a decoder.

In some embodiments, a classification of prediction samples is applied for the diffusion filter.

In some embodiments, a strength factor of the diffusion filter is applied based on at least one of: a result of the classification, a size of the current video block, a shape of the current video block, or a coding mode of the current video block.

In some embodiments, the classification is applied based on at least one of: texture strength information, band information, or variance information.

In some embodiments, the prediction samples are determined based on an intra coding tool, and updated before generating reconstruction samples using the prediction samples.

In some embodiments, a bilateral filter is applied to the prediction samples.

In some embodiments, the intra coding tool comprises at least one of: a regular luma intra mode, an angular based luma intra mode, a wide-angle based luma intra mode, a regular chroma intra mode, an angular based chroma intra mode, or a wide-angle based chroma intra mode.

In some embodiments, the intra coding tool comprises at least one of: a luma decoder-side intra mode derivation (DIMD) mode, a luma template-based intra mode derivation (TIMD) mode, a luma spatial geometric partitioning mode (SGPM) mode, a luma multiple reference line mode (MRL), a luma template-based multiple reference line (TMRL), a luma intra sub-partitions (ISP) mode, a luma fusion-based mode, a luma template matching-based mode, a chroma DIMD mode, a chroma TIMD mode, a chroma SGPM mode, a chroma MRL mode, a chroma TMRL mode, a chroma ISP mode, a chroma fusion-based mode, a chroma template matching-based mode, an intra-convolutional cross-component model (CCCM) mode, a cross component prediction (CCP) mode, a cross-component linear model (CCLM) mode, a multi-model linear model (MMLM) mode, a gradient linear model (GLM) mode, or a chroma non-regular mode.

In some embodiments, the prediction samples are determined based on an intra block copy (IBC) mode, and updated before generating IBC reconstruction samples using the prediction samples.

In some embodiments, the IBC mode comprises at least one of: a luma related IBC mode, a chroma related IBC mode, a reconstruction reordered (RR)-IBC mode, an IBC-Merge mode, an IBC-advanced motion vector prediction (AMVP) mode, an IBC-template matching (TM) mode, a combined intra block copy and intra prediction (IBC-CIIP) mode, an IBC with geometry partitioning (IBC-GPM) mode, an IBC with local illumination compensation (IBC-LIC) mode, a bi-predictive IBC-GPM mode, a bi-predictive IBC mode, or a derived block vector (DBV) mode.

In some embodiments, the prediction samples are determined based on an intra-template matching prediction (TMP) mode, and updated before generating intra-TMP reconstruction samples using the prediction samples.

In some embodiments, the intra-TMP mode comprises at least one of: a luma related intra-TMP mode, a chroma related intra-TMP mode, or an intra-TMP fusion related mode.

In some embodiments, the prediction samples are determined based on an inter prediction mode, and updated before generating inter reconstruction samples using the prediction samples.

In some embodiments, the inter prediction mode comprises at least one of: a luma related inter mode, a chroma related inter mode, a uni-predictive inter mode, a bi-predictive inter mode, an inter merge mode, an inter advanced motion vector prediction (AMVP) mode, an AMVP-merge mode, a combined inter and intra prediction (CIIP) mode, a local illumination compensation (LIC) mode, a bi-directional optic flow (BDOF) mode, an affine mode, a decoder-side motion vector refinement (DMVR) mode, a multi-hypothesis prediction (MHP) mode, an overlapped block motion compensation (OBMC) mode, a geometric partitioning mode (GPM) mode, an inter convolutional cross-component model (CCCM) mode, a bi-prediction with coding unit level weights (BCW) mode, or a template matching based inter mode.

In some embodiments, the prediction samples are updated by applying a filtering process to color components of the prediction samples.

In some embodiments, different filtering processes are applied to different color components of the prediction samples.

In some embodiments, a same filtering process is applied to different color components of the prediction samples.

In some embodiments, the prediction samples are determined based on at least one of: a luma related intra mode, a chroma related intra mode, a cross-component related intra mode, a luma and chroma related intra mode, a fusion based intra mode, or a red green blue color space (RGB) related intra mode.

In some embodiments, the filter process is applied to a coding area of the current video block.

In some embodiments, the coding area comprises at least one of: a coding unit (CU), a prediction unit (PU), a transform unit (TU), a coding tree unit (CTU), a CTU row, a slice, a tile, or a picture.

In some embodiments, whether to and/or how to apply the method 1600 depends on at least one condition.

In some embodiments, the at least one condition comprises at least one of: a type of the prediction samples, a color format of the current video block, a color component of the current video block, a size of the current video block, the number of the prediction samples of the current video block, a size of a picture, a size of a slice, a size of a tile, texture strength information, template information, or information on coding mode of neighbouring blocks of the current video block.

In some embodiments, the method 1600 further comprises: in accordance with a determination that a width or a height of the current video block is greater than a threshold, applying the method.

In some embodiments, the method 1600 further comprises: in accordance with a determination that a width or a height of the current video block is less than a threshold, applying the method.

In some embodiments, the method 1600 further comprises: in accordance with a determination that the number of samples of the current video block is greater than a threshold, applying the method.

In some embodiments, the method 1600 further comprises: in accordance with a determination that the number of samples of the current video block is less than a threshold, applying the method.

In some embodiments, the method 1600 further comprises: in accordance with a determination that the number of the prediction samples of the current video block is greater than a threshold, applying the method.

In some embodiments, the method 1600 further comprises: in accordance with a determination that the number of the prediction samples of the current video block is less than a threshold, applying the method.

In some embodiments, the method 1600 further comprises: in accordance with a determination that a width or a height of at least one of: the picture, the slice, or the tile is greater than a threshold, applying the method.

In some embodiments, the method 1600 further comprises: in accordance with a determination that a width or a height of at least one of: the picture, the slice, or the tile is less than a threshold, applying the method.

In some embodiments, the method 1600 further comprises: in accordance with a determination that the number of samples of at least one of: the picture, the slice, or the tile is greater than a threshold, applying the method.

In some embodiments, the method 1600 further comprises: in accordance with a determination that the number of samples of at least one of: the picture, the slice, or the tile is less than a threshold, applying the method.

In some embodiments, the method 1600 further comprises: in accordance with a determination that a variance of the prediction samples is less than a threshold, applying the method.

In some embodiments, the method 1600 further comprises: in accordance with a determination that a variance of the prediction samples is greater than a threshold, applying the method.

In some embodiments, the method 1600 further comprises: in accordance with a determination that a gradient of the prediction samples is greater than a threshold, applying the method.

In some embodiments, the method 1600 further comprises: in accordance with a determination that a gradient of the prediction samples is less than a threshold, applying the method.

In some embodiments, the method 1600 further comprises: in accordance with a determination that a valid band number of the prediction samples is greater than a threshold, applying the method.

In some embodiments, the method 1600 further comprises: in accordance with a determination that a valid band number of the prediction samples is less than a threshold, applying the method.

In some embodiments, the method 1600 further comprises: in accordance with a determination that a further texture related value of the prediction samples is greater than a threshold, applying the method.

In some embodiments, the method 1600 further comprises: in accordance with a determination that a further texture related value of the prediction samples is less than a threshold, applying the method.

In some embodiments, the method 1600 further comprises: in accordance with a determination that template cost of the current video block is greater than a threshold, applying the method.

In some embodiments, the method 1600 further comprises: in accordance with a determination that template cost of the current video block is greater than a threshold, applying the method.

In some embodiments, the method 1600 further comprises: in accordance with a determination that at least one neighbouring block of the current video block is coded with an intra related mode, applying the method.

In some embodiments, the method 1600 further comprises: in accordance with a determination that at least one neighbouring block of the current video block is coded with at least one of: an inter related mode, an IBC related mode, or an intra-TMP related mode, applying the method.

In some embodiments, the at least one condition is used independently.

In some embodiments, the at least one condition comprises a plurality of jointly used conditions.

In some embodiments, the method 1600 further comprises: applying a padding process to the prediction samples before the filtering process.

In some embodiments, the padding process comprises one of: a mirrored padding process, or a duplicated padding process.

In some embodiments, reconstruction samples of neighbouring blocks of the current video block are used for the prediction samples locating at filtering boundaries of the current video block.

In some embodiments, reconstruction samples of neighbouring blocks of the current video block are used for the padding process.

In some embodiments, the prediction samples of the current video block are used for the padding process.

In some embodiments, a syntax element is included in the bitstream to indicate whether to apply the method 1600.

In some embodiments, the syntax element comprises a flag.

In some embodiments, the method 1600 further comprises: in accordance with a determination that the current video block is coded with a first mode, coding the syntax element, the first mode comprising an angular based intra mode.

In some embodiments, the method 1600 further comprises: in accordance with a determination that the current video block is coded with a second mode, coding the syntax element, the second mode comprising an inter mode.

In some embodiments, the syntax element is coded with at least one context model.

In some embodiments, the syntax element is bypass coded.

In some embodiments, whether the syntax element is coded depends on at least one of: a size of the current video block, a shape of the current video block, or color components of the current video block.

In some embodiments, the syntax element is included in the bitstream for one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

In some embodiments, the method is used in a post-processing and/or pre-processing.

In some embodiments, the method is applied to at least one of: an in-loop filtering tool, a prediction tool, a pre-processing filtering coding tool, or a post-processing filtering coding tool.

In some embodiments, the current video unit comprises at least one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region containing more than one luma or chroma sample.

In some embodiments, an indication of whether to and/or how to apply the method 1600 is included in the bitstream.

In some embodiments, the indication is indicated at one of: a sequence level, a group of pictures level, a picture level, a slice level, or a tile group level.

In some embodiments, the indication is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the indication is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to apply the method 1600 depends on coded information, the coded information comprising at least one of: a block size, a color format, a single and/or dual tree partitioning, a color component, a slice type, or a picture type.

In some embodiments, the conversion includes encoding the current video block into the bitstream.

In some embodiments, the conversion includes decoding the current video block from the bitstream.

According to further embodiments of the present disclosure, a non-transitory computer-readable recording medium is provided. The non-transitory computer-readable recording medium stores a bitstream of a video which is generated by a method performed by an apparatus for video processing. The method comprises: determining prediction samples of a current video block of the video; updating the prediction samples of the current video block based on a filtering process; and generating the bitstream based on the updated prediction samples.

According to still further embodiments of the present disclosure, a method for storing bitstream of a video is provided. The method comprises: determining prediction samples of a current video block of the video; updating the prediction samples of the current video block based on a filtering process; generating the bitstream based on the updated prediction samples; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, prediction samples of the current video block; updating the prediction samples of the current video block based on a filtering process; and performing the conversion based on the updated prediction samples.

Clause 2. The method of clause 1, wherein the prediction samples are determined based on at least one of: an intra prediction mode, an inter prediction mode, a combined inter and intra prediction (CIIP) prediction mode, a spatial geometric partitioning mode (SGPM), an intra block copy (IBC) mode, an intra template matching mode, an affine prediction mode, a merge prediction mode, an advanced motion vector prediction (AMVP) mode, a geometric partitioning mode (GPM) prediction mode, a decoder-side motion vector refinement (DMVR) prediction mode, a bi-directional optical flow (BDOF) prediction mode, a merge mode with motion vector difference (MMVD) prediction, a matrix based intra prediction (MIP) mode, a cross-component prediction mode, or a subblock-based temporal motion vector prediction (SbTMVP) mode.

Clause 3. The method of clause 1 or claim 2, wherein the filtering process comprises at least one of: a bilateral filter (BF), a deblocking filter, a Gaussian filter, a Hadamard domain filter (HDF), a diffusion filter, a low-pass filter, a high-pass filter, a linear filter, or a non-linear filter.

Clause 4. The method of clause 1 or claim 2, wherein at least one parameter is included in the bitstream to determine the filtering process, the filtering process comprising at least one of: a sample-adaptive offset (SAO), a cross-component sample-adaptive offset (CC-SAO), an adaptive loop filter (ALF), or a cross-component adaptive loop filter (CC-ALF).

Clause 5. The method of any of clauses 1 to 4, wherein the filtering process or a further filtering process is applied to reconstruction samples of the current video block.

Clause 6. The method of clause 5, wherein the prediction samples and the reconstruction samples are included in one of: a video unit, a coding unit (CU), a prediction unit (PU), a transform unit (TU), a picture, a slice, a tile, a block, or a region.

Clause 7. The method of any of clauses 1 to 4, wherein a prediction sample of the prediction samples is updated by a bilateral filter with coded information or statistical information.

Clause 8. The method of clause 7, wherein a value of the prediction sample is updated as follows:

$${I}_{filtered} = {I}_{C} + e \times [ {\sum }_{i = 0}^{i = n} μ ( {Δ}_{i} , {Ω}_{i} ) ] ,$$

wherein I_{C} represents the value of the prediction sample locating at a centre of a filtering shape of the filtering process, the prediction sample comprising an luma sample or a chroma sample, I_{filtered} represents a value of the updated prediction sample updated by the bilateral filter, the updated prediction sample comprising an updated luma sample or an updated chroma sample, Δᵢ represents a difference associated with an i-th prediction sample of prediction samples in the filtering shape between a corresponding reference sample and the prediction sample locating at the centre of the filtering shape, Ωᵢ represents a sum of a vertical distance and a horizontal distance associated with the i-th prediction sample between the reference sample and the prediction sample locating at the centre of the filtering shape, n represents the number of prediction samples in the filtering shape, e represents a strength factor, and μ( ) represents a function for determining a filtering weight of each position in the filtering shape.

Clause 9. The method of clause 8, wherein μ( ) is as follows:

$$μ ( Δ , Ω ) = ( {e}^{- \frac{{Δ}^{2}}{2 {σ}_{r}^{2}}} \times Δ ) \times \frac{{e}^{- \frac{( Ω - 1 )}{2 {σ}_{d}^{2}}}}{1 + 4 {e}^{- \frac{1}{2 {σ}_{d}^{2}}}} ,$$

wherein σ_{d} and σᵣ represents two parameters for the filtering process, A represents a difference between the corresponding reference sample and the prediction sample locating at the centre of the filtering shape, and Ω represents the sum of the vertical distance and the horizontal distance between the reference sample and the prediction sample locating at the centre of the filtering shape.

Clause 10. The method of clause 8, wherein μ( ) is added into a look-up table.

Clause 11. The method of clause 10, wherein same parameters or look-up table of the bilateral filter are used for different prediction samples or different positions in an intra prediction of the current video block.

Clause 12. The method of clause 10, wherein different parameters or look-up tables of the bilateral filter are used for different prediction samples or different positions in an intra prediction of the current video block.

Clause 13. The method of clause 9, wherein parameters of the bilateral filter are predefined, searched in a look-up table, determined on-the-fly, or included in the bitstream.

Clause 14. The method of clause 13, wherein the parameters of the bilateral filter are determined based on at least one of the followings of the current video block: a coding mode, a size, or coded information.

Clause 15. The method of clause 13, wherein the parameters of the bilateral filter are indicated in the bitstream from an encoder to a decoder.

Clause 16. The method of clause 13, wherein the parameters of the bilateral filter comprise the strength factor.

Clause 17. The method of clause 16, wherein the strength factor is determined based on at least one of the followings of the current video block: a coding mode, a size, or coded information.

Clause 18. The method of clause 17, wherein the strength factor is determined based on a luma size of the current video block.

Clause 19. The method of clause 18, wherein the strength factor is determined based on max(widthₗᵤₘₐ, heightₗᵤₘₐ) or min(widthₗᵤₘₐ, heightₗᵤₘₐ), widthₗᵤₘₐ representing a luma width of the current video block, and heightₗᵤₘₐ representing a luma height of the current video block.

Clause 20. The method of clause 18, wherein the strength factor is determined based on widthₗᵤₘₐ×heightₗᵤₘₐ, widthₗᵤₘₐ representing a luma width of the current video block, and heightₗᵤₘₐ representing a luma height of the current video block.

Clause 21. The method of clause 17, wherein the strength factor is determined based on a chroma size of the current video block.

Clause 22. The method of clause 21, wherein the strength factor is determined based on max(width_{chroma}, height_{chroma}) or min(width_{chroma}, height_{chroma}), width_{chroma} representing a chroma width of the current video block, and height_{chroma} representing a chroma height of the current video block.

Clause 23. The method of clause 21, wherein the strength factor is determined based on width_{chroma}×height_{chroma}, width_{chroma} representing a chroma width of the current video block, and height_{chroma} representing a chroma height of the current video block.

Clause 24. The method of clause 16, wherein the strength factor is included in the bitstream from an encoder to a decoder.

Clause 25. The method of any of clauses 7 to 24, wherein the filtering process is applied by operations on integers.

Clause 26. The method of clause 25, wherein variables used in the filtering process are left-shifted and/or right-shifted before the filtering process, in the filtering process, or after the filtering process.

Clause 27. The method of any of clauses 7 to 26, wherein a classification of prediction samples is applied for the bilateral filter.

Clause 28. The method of clause 27, wherein the classification is applied based on at least one of: texture strength information, band information, or variance information.

Clause 29. The method of clause 27 or claim 28, wherein the strength factor of the bilateral filter is applied based on at least one of: a result of the classification, a size of the current video block, a shape of the current video block, a coding mode of the current video block, or a color component of the current video block.

Clause 30. The method of clause 29, wherein the classification is applied for a luma component of the current video block and not applied for chroma components of the current video block.

Clause 31. The method of any of clauses 1 to 4, wherein a prediction sample of the prediction samples is updated by an HDF with coded information or statistical information.

Clause 32. The method of clause 31, wherein a value of the updated prediction sample is determined as follows:

$$F ( i , σ ) = \{ \begin{matrix}R ( i ) , Abs ( R ( i ) ) > THR \\ LUT ( R ( i ) , σ ) , R ( i ) > 0 \\ - LUT ( R ( i ) , σ ) , R ( i ) \leq 0\end{matrix} ,$$

wherein, F(i,σ) represents an output of the HDF that is considered as the value of an i-th prediction sample, σ represents a parameter, R(i) represents a Hadamard transform associated with the i-th prediction sample, THR represents a threshold, Abs( ) represents a function for determining an absolute value, and LUT( ) represents a function.

Clause 33. The method of clause 32, wherein LUT( ) is as follows:

$$LUT ( R ( i ) , σ ) = \frac{{R ( i )}^{3}}{{R ( i )}^{2} + {σ}^{2}} ,$$

wherein R(i) represents a Hadamard transform associated with the i-th prediction sample.

Clause 34. The method of clause 32 or claim 33, wherein σ is predefined, derived, or included in the bitstream.

Clause 35. The method of clause 34, wherein σ is predefined based on at least one of the followings of the current video block: a size, a shape, or a coding mode.

Clause 36. The method of clause 34 or claim 35, wherein σ is indicated in the bitstream from an encoder.

Clause 37. The method of clause 34 or claim 35, wherein 6 is derived at a decoder.

Clause 38. The method of any of clauses 31 to 37, wherein a classification of prediction samples is applied for the HDF.

Clause 39. The method of clause 38, wherein the classification is applied based on at least one of: texture strength information, band information, or variance information.

Clause 40. The method of clause 38 or claim 39, wherein a strength factor of the HDF is applied based on at least one of: a result of the classification, a size of the current video block, a shape of the current video block, a coding mode of the current video block, or a color component of the current video block.

Clause 41. The method of clause 40, wherein the classification is applied for a luma component of the current video block and not applied for chroma components of the current video block.

Clause 42. The method of any of clauses 1 to 4, wherein a prediction sample of the prediction samples is updated by a low-pass smooth filter with coded information or statistical information.

Clause 43. The method of clause 42, wherein a value of the updated prediction sample is determined by using neighbouring samples left and above to the current video block as follows: P(x,y)=(W1*L(−1,y)+W2*A(x,−1)+W3*pred(x,y)+K)>>N, wherein (x,y) representing a coordinate of the prediction sample relative to an above left corner sample of the current video block, pred(x,y) represents an original value of the prediction sample, P(x,y) represents the value of the updated prediction sample, W1, W2, and W3 represent weighting factors, L(−1,y) represents a value of a neighbouring sample left to the current video block, A(x,−1) represents a value of a neighbouring sample above to the current video block, >> represents a right shift operation, and K and N are parameters.

Clause 44. The method of clause 43, wherein W1 is 1, W2 is 1, and W3 is 6.

Clause 45. The method of clause 42, wherein a value of the updated prediction sample is determined by using neighbouring samples left and above to the current video block as follows: P(x,y)=(W1*L(−1,y)+W2*L(−2,y)+W3*A(x,−1)+W4*A(x,−2)+W5*pred(x,y)+K)>>N wherein (x,y) representing a coordinate of the prediction sample relative to an above left corner sample of the current video block, pred(x,y) represents an original value of the updated prediction sample, P(x,y) represents the value of the updated prediction sample, W1, W2, W3, W4, and W5 represent weighting factors, L(−1,y) and L(−2,y) represent values of neighbouring samples left to the current video block, A(x,−1) and A(x,−2) represent values of neighbouring samples above to the current video block, >> represents a right shift operation, and K and N are parameters.

Clause 46. The method of clause 45, wherein W1 is 1, W2 is 1, W3 is 1, W4 is 1, and W5 is 12.

Clause 47. The method of clause 43 or claim 45, wherein the weighting factors are predefined based on a size of the current video block.

Clause 48. The method of clause 43 or claim 45, wherein the weighting factors are predefined, derived, or included in the bitstream.

Clause 49. The method of clause 43 or claim 45, wherein the weighting factors are determined based on coding information.

Clause 50. The method of clause 49, wherein the coding information comprises at least one of: a size of the current video block, a shape of the current video block, or a coding mode of the current video block.

Clause 51. The method of any of clauses 42-50, wherein a classification of prediction samples is applied for the low-pass smooth filter.

Clause 52. The method of clause 51, wherein strength of the low-pass smooth filter is applied based on at least one of: a result of the classification, a size of the current video block, a shape of the current video block, or a coding mode of the current video block.

Clause 53. The method of clause 51, wherein the classification is applied based on at least one of: texture strength information, band information, or variance information.

Clause 54. The method of any of clauses 1 to 4, wherein the prediction samples are updated by a diffusion filter with coded information or statistical information.

Clause 55. The method of clause 54, wherein the prediction samples are updated by correlating the prediction samples for n times as follows:

$${u}_{n} = {\underbrace{h * … * h}}_{n times} * pred ,$$

wherein pred represents the prediction samples, uₙ represents the updated prediction samples, h represents the diffusion filter, * represents applying the diffusion filter to the current video block, and n represents a first parameter of the diffusion filter, n being an integer.

Clause 56. The method of clause 55, wherein h is as follows:

$$h = \frac{1}{4 k} [ \begin{matrix}0 & k & 0 \\ k & 0 & k \\ 0 & k & 0\end{matrix} ] ,$$

wherein k represents a second parameter of the diffusion filter.

Clause 57. The method of clause 56, wherein the first and second parameters are predefined, derived or included in the bitstream.

Clause 58. The method of clause 57, wherein the first and second parameters are predefined based on at least one of: a size of the current video block, a shape of the current video block, or a coding mode of the current video block.

Clause 59. The method of clause 57, wherein the first and second parameters are indicated in the bitstream from an encoder.

Clause 60. The method of clause 57, wherein the first and second parameters are derived at a decoder.

Clause 61. The method of any of clauses 54-60, wherein a classification of prediction samples is applied for the diffusion filter.

Clause 62. The method of clause 61, wherein a strength factor of the diffusion filter is applied based on at least one of: a result of the classification, a size of the current video block, a shape of the current video block, or a coding mode of the current video block.

Clause 63. The method of clause 61, wherein the classification is applied based on at least one of: texture strength information, band information, or variance information.

Clause 64. The method of any of clauses 1-63, wherein the prediction samples are determined based on an intra coding tool, and updated before generating reconstruction samples using the prediction samples.

Clause 65. The method of clause 64, wherein a bilateral filter is applied to the prediction samples.

Clause 66. The method of clause 65, wherein the intra coding tool comprises at least one of: a regular luma intra mode, an angular based luma intra mode, a wide-angle based luma intra mode, a regular chroma intra mode, an angular based chroma intra mode, or a wide-angle based chroma intra mode.

Clause 67. The method of clause 65, wherein the intra coding tool comprises at least one of: a luma decoder-side intra mode derivation (DIMD) mode, a luma template-based intra mode derivation (TIMD) mode, a luma spatial geometric partitioning mode (SGPM) mode, a luma multiple reference line mode (MRL), a luma template-based multiple reference line (TMRL), a luma intra sub-partitions (ISP) mode, a luma fusion-based mode, a luma template matching-based mode, a chroma DIMD mode, a chroma TIMD mode, a chroma SGPM mode, a chroma MRL mode, a chroma TMRL mode, a chroma ISP mode, a chroma fusion-based mode, a chroma template matching-based mode, an intra-convolutional cross-component model (CCCM) mode, a cross component prediction (CCP) mode, a cross-component linear model (CCLM) mode, a multi-model linear model (MMLM) mode, a gradient linear model (GLM) mode, or a chroma non-regular mode.

Clause 68. The method of any of clauses 1-63, wherein the prediction samples are determined based on an intra block copy (IBC) mode, and updated before generating IBC reconstruction samples using the prediction samples.

Clause 69. The method of clause 68, wherein the IBC mode comprises at least one of: a luma related IBC mode, a chroma related IBC mode, a reconstruction reordered (RR)-IBC mode, an IBC-Merge mode, an IBC-advanced motion vector prediction (AMVP) mode, an IBC-template matching (TM) mode, a combined intra block copy and intra prediction (IBC-CIIP) mode, an IBC with geometry partitioning (IBC-GPM) mode, an IBC with local illumination compensation (IBC-LIC) mode, a bi-predictive IBC-GPM mode, a bi-predictive IBC mode, or a derived block vector (DBV) mode.

Clause 70. The method of any of clauses 1-63, wherein the prediction samples are determined based on an intra-template matching prediction (TMP) mode, and updated before generating intra-TMP reconstruction samples using the prediction samples.

Clause 71. The method of clause 70, wherein the intra-TMP mode comprises at least one of: a luma related intra-TMP mode, a chroma related intra-TMP mode, or an intra-TMP fusion related mode.

Clause 72. The method of any of clauses 1-63, wherein the prediction samples are determined based on an inter prediction mode, and updated before generating inter reconstruction samples using the prediction samples.

Clause 73. The method of clause 72, wherein the inter prediction mode comprises at least one of: a luma related inter mode, a chroma related inter mode, a uni-predictive inter mode, a bi-predictive inter mode, an inter merge mode, an inter advanced motion vector prediction (AMVP) mode, an AMVP-merge mode, a combined inter and intra prediction (CIIP) mode, a local illumination compensation (LIC) mode, a bi-directional optic flow (BDOF) mode, an affine mode, a decoder-side motion vector refinement (DMVR) mode, a multi-hypothesis prediction (MHP) mode, an overlapped block motion compensation (OBMC) mode, a geometric partitioning mode (GPM) mode, an inter convolutional cross-component model (CCCM) mode, a bi-prediction with coding unit level weights (BCW) mode, or a template matching based inter mode.

Clause 74. The method of any of clauses 1-63, wherein the prediction samples are updated by applying a filtering process to color components of the prediction samples.

Clause 75. The method of clause 74, wherein different filtering processes are applied to different color components of the prediction samples.

Clause 76. The method of clause 74, wherein a same filtering process is applied to different color components of the prediction samples.

Clause 77. The method of any of clauses 74-76, wherein the prediction samples are determined based on at least one of: a luma related intra mode, a chroma related intra mode, a cross-component related intra mode, a luma and chroma related intra mode, a fusion based intra mode, or a red green blue color space (RGB) related intra mode.

Clause 78. The method of any of clauses 1-77, wherein the filter process is applied to a coding area of the current video block.

Clause 79. The method of 78, wherein the coding area comprises at least one of: a coding unit (CU), a prediction unit (PU), a transform unit (TU), a coding tree unit (CTU), a CTU row, a slice, a tile, or a picture.

Clause 80. The method of any of clauses 1-79, wherein whether to and/or how to apply the method depends on at least one condition.

Clause 81. The method of clause 80, wherein the at least one condition comprises at least one of: a type of the prediction samples, a color format of the current video block, a color component of the current video block, a size of the current video block, the number of the prediction samples of the current video block, a size of a picture, a size of a slice, a size of a tile, texture strength information, template information, or information on coding mode of neighbouring blocks of the current video block.

Clause 82. The method of clause 81, further comprising: in accordance with a determination that a width or a height of the current video block is greater than a threshold, applying the method.

Clause 83. The method of clause 81, further comprising: in accordance with a determination that a width or a height of the current video block is less than a threshold, applying the method.

Clause 84. The method of clause 81, further comprising: in accordance with a determination that the number of samples of the current video block is greater than a threshold, applying the method.

Clause 85. The method of clause 81, further comprising: in accordance with a determination that the number of samples of the current video block is less than a threshold, applying the method.

Clause 86. The method of clause 81, further comprising: in accordance with a determination that the number of the prediction samples of the current video block is greater than a threshold, applying the method.

Clause 87. The method of clause 81, further comprising: in accordance with a determination that the number of the prediction samples of the current video block is less than a threshold, applying the method.

Clause 88. The method of clause 81, further comprising: in accordance with a determination that a width or a height of at least one of: the picture, the slice, or the tile is greater than a threshold, applying the method.

Clause 89. The method of clause 81, further comprising: in accordance with a determination that a width or a height of at least one of: the picture, the slice, or the tile is less than a threshold, applying the method.

Clause 90. The method of clause 81, further comprising: in accordance with a determination that the number of samples of at least one of: the picture, the slice, or the tile is greater than a threshold, applying the method.

Clause 91. The method of clause 81, further comprising: in accordance with a determination that the number of samples of at least one of: the picture, the slice, or the tile is less than a threshold, applying the method.

Clause 92. The method of clause 81, further comprising: in accordance with a determination that a variance of the prediction samples is less than a threshold, applying the method.

Clause 93. The method of clause 81, further comprising: in accordance with a determination that a variance of the prediction samples is greater than a threshold, applying the method.

Clause 94. The method of clause 81, further comprising: in accordance with a determination that a gradient of the prediction samples is greater than a threshold, applying the method.

Clause 95. The method of clause 81, further comprising: in accordance with a determination that a gradient of the prediction samples is less than a threshold, applying the method.

Clause 96. The method of clause 81, further comprising: in accordance with a determination that a valid band number of the prediction samples is greater than a threshold, applying the method.

Clause 97. The method of clause 81, further comprising: in accordance with a determination that a valid band number of the prediction samples is less than a threshold, applying the method.

Clause 98. The method of clause 81, further comprising: in accordance with a determination that a further texture related value of the prediction samples is greater than a threshold, applying the method.

Clause 99. The method of clause 81, further comprising: in accordance with a determination that a further texture related value of the prediction samples is less than a threshold, applying the method.

Clause 100. The method of clause 81, further comprising: in accordance with a determination that template cost of the current video block is greater than a threshold, applying the method.

Clause 101. The method of clause 81, further comprising: in accordance with a determination that template cost of the current video block is greater than a threshold, applying the method.

Clause 102. The method of clause 81, further comprising: in accordance with a determination that at least one neighbouring block of the current video block is coded with an intra related mode, applying the method.

Clause 103. The method of clause 81, further comprising: in accordance with a determination that at least one neighbouring block of the current video block is coded with at least one of: an inter related mode, an IBC related mode, or an intra-TMP related mode, applying the method.

Clause 104. The method of clause 81, wherein the at least one condition is used independently.

Clause 105. The method of clause 81, wherein the at least one condition comprises a plurality of jointly used conditions.

Clause 106. The method of any of clauses 1-105, further comprising: applying a padding process to the prediction samples before the filtering process.

Clause 107. The method of clause 106, wherein the padding process comprises one of: a mirrored padding process, or a duplicated padding process.

Clause 108. The method of clause 106 or claim 107, wherein reconstruction samples of neighbouring blocks of the current video block are used for the prediction samples locating at filtering boundaries of the current video block.

Clause 109. The method of clause 106 or claim 107, wherein reconstruction samples of neighbouring blocks of the current video block are used for the padding process.

Clause 110. The method of clause 106 or claim 107, wherein the prediction samples of the current video block are used for the padding process.

Clause 111. The method of any of clauses 1-110, wherein a syntax element is included in the bitstream to indicate whether to apply the method in accordance with any of clauses 1 to 110.

Clause 112. The method of clause 111, wherein the syntax element comprises a flag.

Clause 113. The method of clause 111, further comprising: in accordance with a determination that the current video block is coded with a first mode, coding the syntax element, the first mode comprising an angular based intra mode.

Clause 114. The method of clause 111, further comprising: in accordance with a determination that the current video block is coded with a second mode, coding the syntax element, the second mode comprising an inter mode.

Clause 115. The method of clause 111, wherein the syntax element is coded with at least one context model.

Clause 116. The method of clause 111, wherein the syntax element is bypass coded.

Clause 117. The method of clause 111, wherein whether the syntax element is coded depends on at least one of: a size of the current video block, a shape of the current video block, or color components of the current video block.

Clause 118. The method of clause 111, wherein the syntax element is included in the bitstream for one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 119. The method of any of clauses 1-118, wherein the method is used in a post-processing and/or pre-processing.

Clause 120. The method of any of clauses 1-119, wherein the method is applied to at least one of: an in-loop filtering tool, a prediction tool, a pre-processing filtering coding tool, or a post-processing filtering coding tool.

Clause 121. The method of any of clauses 1-120, wherein the current video unit comprises at least one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region containing more than one luma or chroma sample.

Clause 122. The method of any of clauses 1-121, wherein an indication of whether to and/or how to apply the method is included in the bitstream.

Clause 123. The method of clause 122, wherein the indication is indicated at one of: a sequence level, a group of pictures level, a picture level, a slice level, or a tile group level.

Clause 124. The method of clause 122, wherein the indication is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 125. The method of clause 122, wherein the indication is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 126. The method of any of clauses 1-125, wherein whether to and/or how to apply the method depends on coded information, the coded information comprising at least one of: a block size, a color format, a single and/or dual tree partitioning, a color component, a slice type, or a picture type.

Clause 127. The method of any of clauses 1-126, wherein the conversion includes encoding the current video block into the bitstream.

Clause 128. The method of any of clauses 1-126, wherein the conversion includes decoding the current video block from the bitstream.

Clause 129. An apparatus for video processing comprising a processor and a non-transitory memory with instructions thereon, wherein the instructions upon execution by the processor, cause the processor to perform a method in accordance with any of clauses 1-128.

Clause 130. A non-transitory computer-readable storage medium storing instructions that cause a processor to perform a method in accordance with any of clauses 1-128.

Clause 131. A non-transitory computer-readable recording medium storing a bitstream of a video which is generated by a method performed by an apparatus for video processing, wherein the method comprises: determining prediction samples of a current video block of the video; updating the prediction samples of the current video block based on a filtering process; and generating the bitstream based on the updated prediction samples.

Clause 132. A method for storing a bitstream of a video, comprising: determining prediction samples of a current video block of the video; updating the prediction samples of the current video block based on a filtering process; generating the bitstream based on the updated prediction samples; and storing the bitstream in a non-transitory computer-readable recording medium.

### Example Device

FIG. 17 illustrates a block diagram of a computing device 1700 in which various embodiments of the present disclosure can be implemented. The computing device 1700 may be implemented as or included in the source device 110 (or the video encoder 114 or 200) or the destination device 120 (or the video decoder 124 or 300).

It would be appreciated that the computing device 1700 shown in FIG. 17 is merely for purpose of illustration, without suggesting any limitation to the functions and scopes of the embodiments of the present disclosure in any manner.

As shown in FIG. 17, the computing device 1700 includes a general-purpose computing device 1700. The computing device 1700 may at least comprise one or more processors or processing units 1710, a memory 1720, a storage unit 1730, one or more communication units 1740, one or more input devices 1750, and one or more output devices 1760.

In some embodiments, the computing device 1700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1700 can support any type of interface to a user (such as “wearable” circuitry and the like).

The processing unit 1710 may be a physical or virtual processor and can implement various processes based on programs stored in the memory 1720. In a multi-processor system, multiple processing units execute computer executable instructions in parallel so as to improve the parallel processing capability of the computing device 1700. The processing unit 1710 may also be referred to as a central processing unit (CPU), a microprocessor, a controller or a microcontroller.

The computing device 1700 typically includes various computer storage medium. Such medium can be any medium accessible by the computing device 1700, including, but not limited to, volatile and non-volatile medium, or detachable and non-detachable medium. The memory 1720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1730 may be any detachable or non-detachable medium and may include a machine-readable medium such as a memory, flash memory drive, magnetic disk or another other media, which can be used for storing information and/or data and can be accessed in the computing device 1700.

The computing device 1700 may further include additional detachable/non-detachable, volatile/non-volatile memory medium. Although not shown in FIG. 17, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1740 communicates with a further computing device via the communication medium. In addition, the functions of the components in the computing device 1700 can be implemented by a single computing cluster or multiple computing machines that can communicate via communication connections. Therefore, the computing device 1700 can operate in a networked environment using a logical connection with one or more other servers, networked personal computers (PCs) or further general network nodes.

The input device 1750 may be one or more of a variety of input devices, such as a mouse, keyboard, tracking ball, voice-input device, and the like. The output device 1760 may be one or more of a variety of output devices, such as a display, loudspeaker, printer, and the like. By means of the communication unit 1740, the computing device 1700 can further communicate with one or more external devices (not shown) such as the storage devices and display device, with one or more devices enabling the user to interact with the computing device 1700, or any devices (such as a network card, a modem and the like) enabling the computing device 1700 to communicate with one or more other computing devices, if required. Such communication can be performed via input/output (I/O) interfaces (not shown).

In some embodiments, instead of being integrated in a single device, some or all components of the computing device 1700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1700 may be used to implement video encoding/decoding in embodiments of the present disclosure. The memory 1720 may include one or more video coding modules 1725 having one or more program instructions. These modules are accessible and executable by the processing unit 1710 to perform the functionalities of the various embodiments described herein.

In the example embodiments of performing video encoding, the input device 1750 may receive video data as an input 1770 to be encoded. The video data may be processed, for example, by the video coding module 1725, to generate an encoded bitstream. The encoded bitstream may be provided via the output device 1760 as an output 1780.

In the example embodiments of performing video decoding, the input device 1750 may receive an encoded bitstream as the input 1770. The encoded bitstream may be processed, for example, by the video coding module 1725, to generate decoded video data. The decoded video data may be provided via the output device 1760 as the output 1780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for video processing, comprising:
determining, for a conversion between a current video block of a video and a bitstream of the video, prediction samples of the current video block;
updating the prediction samples of the current video block based on a filtering process; and
performing the conversion based on the updated prediction samples.

2. The method of claim 1, wherein the prediction samples are determined based on at least one of: an intra prediction mode, an inter prediction mode, an intra block copy (IBC) mode, an affine prediction mode, or a matrix based intra prediction (MIP) mode, and/or
wherein the filtering process comprises at least one of: a bilateral filter (BF), or a Hadamard domain filter (HDF), and/or
wherein at least one parameter is included in the bitstream to determine the filtering process, the filtering process comprising at least one of: a sample-adaptive offset (SAO), a cross-component sample-adaptive offset (CC-SAO), an adaptive loop filter (ALF), or a cross-component adaptive loop filter (CC-ALF), and/or
wherein the filtering process or a further filtering process is applied to reconstruction samples of the current video block, wherein the prediction samples and the reconstruction samples are included in one of: a video unit, a coding unit (CU), a prediction unit (PU), or a transform unit (TU).

3. The method of claim 1, wherein a prediction sample of the prediction samples is updated by a bilateral filter with coded information or statistical information,
wherein a value of the prediction sample is updated as follows:
$${I}_{filtered} = {I}_{C} + e \times [ {\sum }_{i = 0}^{i = n} μ ( {Δ}_{i} , {Ω}_{i} ) ] ,$$
wherein I_{C} represents the value of the prediction sample locating at a centre of a filtering shape of the filtering process, the prediction sample comprising an luma sample or a chroma sample, I_{filtered} represents a value of the updated prediction sample updated by the bilateral filter, the updated prediction sample comprising an updated luma sample or an updated chroma sample, Δᵢ represents a difference associated with an i-th prediction sample of prediction samples in the filtering shape between a corresponding reference sample and the prediction sample locating at the centre of the filtering shape, Ωᵢ represents a sum of a vertical distance and a horizontal distance associated with the i-th prediction sample between the reference sample and the prediction sample locating at the centre of the filtering shape, n represents the number of prediction samples in the filtering shape, e represents a strength factor, and μ( ) represents a function for determining a filtering weight of each position in the filtering shape, and wherein μ( ) is added into a look-up table.

4. The method of claim 3, wherein parameters of the bilateral filter are predefined, searched in a look-up table, determined on-the-fly, or included in the bitstream, wherein the parameters of the bilateral filter comprise the strength factor, wherein the strength factor is determined based on at least one of the followings of the current video block: a coding mode, a size, or coded information, or
wherein the filtering process is applied by operations on integers, and/or
wherein a classification of prediction samples is applied for the bilateral filter, wherein the classification is applied based on variance information, and/or
wherein the strength factor of the bilateral filter is applied based on at least one of: a result of the classification, a size of the current video block, or a coding mode of the current video block.

5. The method of claim 1, wherein a prediction sample of the prediction samples is updated by an HDF with coded information or statistical information,
wherein a value of the updated prediction sample is determined as follows:
$$F ( i , σ ) = \{ \begin{matrix}R ( i ) , Abs ( R ( i ) ) > THR \\ LUT ( R ( i ) , σ ) , R ( i ) > 0 \\ - LUT ( R ( i ) , σ ) , R ( i ) \leq 0\end{matrix} ,$$
wherein, F(i,σ) represents an output of the HDF that is considered as the value of an i-th prediction sample, Υ represents a parameter, R(i) represents a Hadamard transform associated with the i-th prediction sample, THR represents a threshold, Abs( ) represents a function for determining an absolute value, and LUT( ) represents a function,
wherein σ is predefined based on at least one of the followings of the current video block: a size, a shape, or a coding mode.

6. The method of claim 5, wherein a classification of prediction samples is applied for the HDF, wherein the classification is applied based on variance information, and/or
wherein a strength factor of the HDF is applied based on at least one of: a result of the classification, a size of the current video block, or a coding mode of the current video block.

7. The method of claim 1, wherein a prediction sample of the prediction samples is updated by a low-pass smooth filter with coded information or statistical information,
wherein a value of the updated prediction sample is determined by using neighbouring samples left and above to the current video block as follows:
$$P ( x , y ) = ( W 1 * L ( - 1 , y ) + W 2 * A ( x , - 1 ) + W 3 * pred ( x , y ) + K ) >> N ,$$
wherein (x,y) representing a coordinate of the prediction sample relative to an above left corner sample of the current video block, pred(x,y) represents an original value of the prediction sample, P(x,y) represents the value of the updated prediction sample, W1, W2, and W3 represent weighting factors, L(−1,y) represents a value of a neighbouring sample left to the current video block, A(x,−1) represents a value of a neighbouring sample above to the current video block, >> represents a right shift operation, and K and N are parameters, wherein the weighting factors are determined based on coding information, wherein the coding information comprises a coding mode of the current video block.

8. The method of claim 7, wherein a classification of prediction samples is applied for the low-pass smooth filter,
wherein strength of the low-pass smooth filter is applied based on at least one of:
a result of the classification,
a size of the current video block,
a shape of the current video block, or
a coding mode of the current video block, or
wherein the classification is applied based on variance information.

9. The method of claim 1, wherein the prediction samples are updated by a diffusion filter with coded information or statistical information,
wherein the prediction samples are updated by correlating the prediction samples for n times as follows:
$${u}_{n} = {\underbrace{h * … * h}}_{n times} * pred ,$$
wherein pred represents the prediction samples, uₙ represents the updated prediction samples, h represents the diffusion filter, * represents applying the diffusion filter to the current video block, and n represents a first parameter of the diffusion filter, n being an integer,
wherein h is as follows:
$$h = \frac{1}{4 k} [ \begin{matrix}0 & k & 0 \\ k & 0 & k \\ 0 & k & 0\end{matrix} ] ,$$
wherein k represents a second parameter of the diffusion filter,
wherein the first and second parameters are predefined, derived or included in the bitstream,
wherein the first and second parameters are predefined based on at least one of: a size of the current video block, a shape of the current video block, or a coding mode of the current video block, and/or wherein a classification of prediction samples is applied for the diffusion filter,
wherein a strength factor of the diffusion filter is applied based on at least one of: a result of the classification, a size of the current video block, a shape of the current video block, or a coding mode of the current video block, wherein the classification is applied based on variance information.

10. The method of claim 1, wherein the prediction samples are determined based on an intra coding tool, and updated before generating reconstruction samples using the prediction samples,
wherein a bilateral filter is applied to the prediction samples,
wherein the intra coding tool comprises at least one of: a regular luma intra mode, or an angular based luma intra mode, or
wherein the intra coding tool comprises at least one of: a luma decoder-side intra mode derivation (DIMD) mode, a luma template-based intra mode derivation (TIMD) mode, a luma fusion-based mode, or a luma template matching-based mode.

11. The method of claim 1, wherein the prediction samples are determined based on an intra block copy (IBC) mode, and updated before generating IBC reconstruction samples using the prediction samples, wherein the IBC mode comprises at least one of: a luma related IBC mode, or a chroma related IBC mode, and/or wherein the prediction samples are determined based on an inter prediction mode, and updated before generating inter reconstruction samples using the prediction samples, wherein the inter prediction mode comprises at least one of: a luma related inter mode, a chroma related inter mode, a uni-predictive inter mode, a bi-predictive inter mode, an inter merge mode, or an inter advanced motion vector predication (AMVP) mode.

12. The method of claim 1, wherein the prediction samples are updated by applying a filtering process to color components of the prediction samples,
wherein different filtering processes are applied to different color components of the prediction samples, or wherein a same filtering process is applied to different color components of the prediction samples, and/or
wherein the prediction samples are determined based on at least one of: a luma related intra mode, or a chroma related intra mode.

13. The method of claim 1, wherein the filter process is applied to a coding area of the current video block, wherein the coding area comprises at least one of: a coding unit (CU), a prediction unit (PU), or a transform unit (TU).

14. The method of claim 1, wherein whether to and/or how to apply the method depends on at least one condition, wherein the at least one condition comprises at least one of: a type of the prediction samples, a size of the current video block, or texture strength information,
wherein the method further comprises at least one of:
in accordance with a determination that a width or a height of the current video block is less than a threshold, applying the method,
in accordance with a determination that the number of samples of the current video block is less than a threshold, applying the method, or
in accordance with a determination that a variance of the prediction samples is less than a threshold, applying the method.

15. The method of claim 1, further comprising:
applying a padding process to the prediction samples before the filtering process,
wherein the padding process comprises a mirrored padding process, and/or
wherein reconstruction samples of neighbouring blocks of the current video block are used for the prediction samples locating at filtering boundaries of the current video block.

16. The method of claim 1, wherein a syntax element is included in the bitstream to indicate whether to apply the method, wherein the syntax element comprises a flag,
wherein the method further comprises at least one of:
in accordance with a determination that the current video block is coded with a first mode, coding the syntax element, the first mode comprising an angular based intra mode, or
in accordance with a determination that the current video block is coded with a second mode, coding the syntax element, the second mode comprising an inter mode.

17. The method of claim 1, wherein the conversion comprises: generating the bitstream from the video, and
the method further comprises: storing the bitstream in a non-transitory computer-readable recording medium.

18. The method of claim 1, wherein the conversion comprises encoding the current video block into the bitstream, or
wherein the conversion comprises decoding the current video block from the bitstream.

19. An apparatus for video processing comprising a processor and a non-transitory memory with instructions thereon, wherein the instructions upon execution by the processor, cause the processor to:
determine, for a conversion between a current video block of a video and a bitstream of the video, prediction samples of the current video block;
update the prediction samples of the current video block based on a filtering process; and
perform the conversion based on the updated prediction samples.

20. A non-transitory computer-readable storage medium storing instructions that cause a processor to perform:
determining, for a conversion between a current video block of a video and a bitstream of the video, prediction samples of the current video block;
updating the prediction samples of the current video block based on a filtering process; and
performing the conversion based on the updated prediction samples.
